(19) United States
(12) Patent Application Publication
(10) Pub. No.: US 2022/0049135 A1
(43) Pub. Date: Feb. 17, 2022

(54) NEW SYSTEMS FOR PRIMING AND ADHESION OF FLOORING

(71) Applicant: COVESTRO INTELLECTUAL PROPERTY GMBH & CO. KG, LEVERKUSEN (DE)

(72) Inventors: Christoph Thiebes, Köln (DE); Maria Almato Guiteras, Barcelona (ES); Eva Tejada Rosales, Mollet del Vallés (ES)

(21) Appl. No.: 17/427,945

(22) PCT Filed: Feb. 11, 2020
(86) PCT No.: PCT/EP2020/053394

§ 371 Date: Aug. 3, 2021

(30) Foreign Application Priority Data
Feb. 15, 2019 (EP) 19157356.7
Nov. 14, 2019 (EP) 19209043.9

(51) Int. Cl. C09J 125/14; C09J 175/04; C09J 5/00

(52) U.S. Cl. CPC C09J 125/14; C09J 175/04; C09J 2475/00; C09J 2425/00; C09J 5/00

(57) ABSTRACT

The present invention relates to a layer structure comprising primer layers based on polyacrylate primers (AG) and compositions based on silane-modified polymers (KS), and to a method of bonding floor coverings on treated bases.

The present invention relates to layer structures comprising primer layers (G) obtainable from polyacrylate primers (AG) and compositions based on silane-modified polymers (KS), and to a method of bonding floor coverings on treated bases.

In many cases, it is advantageous and necessary to bond floor coverings such as parquet, cork, rubber, PVC sheets and tiles, or else linoleum, to bases present in the construction, such as screeds or wood surfaces.

Under particular stresses (temperature and humidity) or in the case of significantly dimensionally unstable floor coverings (e.g. solid wood floorboards), preference is given to using reactive adhesives, for example moisture-curing adhesives based on polyurethane prepolymers.

A more recent development suitable for this use is that of adhesives based on silane-modified oligomeric compounds, called SMP adhesives (silane-modified polymer adhesives, sometimes also called hybrid adhesives or silane-terminated polymer adhesives). These adhesives are characterized by oligomeric organic compounds (frequently also referred to as prepolymers) that bear moisture-reactive silane groups, usually dimethoxymethyl- or trimethoxysilane groups. Silane-modified polymers (SMPs) can be obtained in a very simple manner from polyurethane polymers containing isocyanate groups, by trans-functionalizing the isocyanate groups thereof by means of amino-, thio- or hydroxysilanes to give silane groups. Silane-modified polymers that are free of urea groups and contain only few urethane groups, if any, are likewise known and are obtainable, for example, by reacting polyether polyols with isocyanatosilanes or by hydrosilylation of allyl-functional polyethers. Silane-modified polymers that have been modified with silane groups at each end of the polymer backbone are also referred to as silane-terminated polymers (STPs). After contact with moisture from the base or the air, the moisture-reactive silane groups crosslink via hydrolysis and subsequent condensation to give a three-dimensional siloxane network, the adhesive matrix.

Further constituents of these adhesives are liquid extenders, plasticizers, mineral fillers, water scavengers, adhesion promoters, catalysts and further auxiliaries. For the bonding of floor coverings, adhesives based on silane-modified polymers generally have the following advantages: one-component composition, absence of water and solvents, sufficiently long open times, no practically relevant wood-swelling effect, no labeling obligation under the German hazardous substances legislation and the international GHS labeling system. Also advantageous is the pseudoplastic rheology of SMP adhesives. What this means in practice is that the adhesives do not run and can be applied efficiently with a toothed trowel. Drawn adhesive beads remain dimensionally stable and hence provide an important prerequisite for being able to bridge small cavities between floor covering and base.

Silane-modified polymer adhesives typically contain plasticizers and/or unreactive liquid extenders that lower the viscosity of the adhesive and guarantee necessary processing properties. These are regrettably also responsible for a number of performance problems and limitations. The dissolution properties of these liquids that are capable of migration may trigger, for example, partial dissolution of mastic asphalt screed as base, which is the reason why this has to be primed with plasticizer-containing silane-modified polymer adhesives prior to bonding of a floor covering.

In this case, the primer must have sufficient plasticizer resistance, meaning that it must not be partly dissolved by the plasticizer from the adhesive, which would reduce its strength, and there must be no migration of the plasticizer through the primer into the mastic asphalt.

Purely physically setting dispersion primers that are typically used as primers for development of adhesion and for dust binding, based on vinyl acetate-ethylene, styrene-acrylate or acrylic ester copolymers, are not resistant to plasticizers and do not develop sufficient adhesion to silane-modified adhesives. Adhesion problems are therefore fundamentally to be expected in the case of silane-modified adhesives, especially but not necessarily when these contain migration constituents.

Higher plasticizer resistance is achieved by reactive systems consisting of 2 components that react with one another, for example aqueous, solventborne or 100% 2K epoxy primers. These systems have the disadvantage of too short a pot life or too long a waiting time before the primer can be walked on.

The prior art further includes polyurethane primers that generally have one component (1-K) and are based on diphenylmethane diisocyanate prepolymers (MDI). These have excellent plasticizer resistance. A major disadvantage, however, is that the curing reactions and hence also the ultimate state of the polymer film that forms are highly dependent on the ambient conditions, especially the room temperature, the relative ambient humidity, the base temperature and the water content of the base. A problem here is the different degree of evolution of CO₂ evolved during the curing reactions, which leads to a porous polymer film, and this worsens both mechanical and water vapor diffusion barrier properties. On account of the layer thickness-dependent tendency to foaming through evolution of CO₂, the layer thicknesses necessary for an effective barrier against moisture or migration of plasticizers must be applied in two operations, generally with the need to observe wait times of at least 12 h after the last operation before the application of adhesives, especially of SMP adhesives.

It is therefore an object of the present invention to discover systems consisting of primer and adhesive for the bonding of wood, cork, linoleum, rubber and/or PVC flooring on bases present in the construction, such as screeds, tiles or wood surfaces, and a method of using this system consisting of primer and adhesive for the bonding of wood, cork, linoleum, rubber and/or PVC floors on bases present in the construction, for example screeds or wood surfaces, which does not have the disadvantages known in the prior art, for example unsuitable plasticizer resistance, long wait times for curing of the primer before application of adhesive, repeated application of the primer and evolution of CO₂.

It has been shown in the context of the present invention that, surprisingly, systems consisting of self-crosslinking polyacrylate primer (AG) and compositions based on silane-modified polymers (KS) are of excellent suitability for the bonding of wood, cork, linoleum, rubber and/or PVC floors on bases present in the construction, for example screeds or wood surfaces, and do not have the disadvantages described in the prior art, for example unsuitable plasticizer resistance of the primer, long wait times for curing of the primer before application of adhesive, need for repeated application of the primer before application of adhesive, mixing, and short pot lives and processing times of the primer.

The object of the present invention was achieved by the layer structure of primer layers (G) obtainable from polyacrylate primers (AG) and curable compositions based on silane-modified polymers (KS).

In the context of the present invention, a “composition” is understood to mean a mixture of at least two ingredients.

The term “curable” shall be understood to mean that the composition can be converted from a relatively flexible, possibly plastically deformable state to a harder state under the influence of external conditions, especially under the influence of moisture present in the environment and/or intentionally supplied. The crosslinking can generally be effected through chemical and/or physical influences in addition to the moisture already mentioned, i.e., for example, also through supply of energy in the form of heat, light or other electromagnetic radiation, but also by simple contacting of the composition with air or a reactive component.

In the context of the present invention, that of the layer structure of primer layer (G) obtainable from polyacrylate primer (AG) and composition based on silane-modified polymers (KS), the composition (KS) includes the following silane-modified polymers having at least one end group of the general formula (I):

-Aₙ-R-SiVYZ (I)

in which
A is a divalent binding group containing at least one heteroatom,
R is a divalent hydrocarbyl radical having 1-12 carbon atoms,
V, Y, Z are substituents on the silicon atom that are independently C₁-C₈-alkyl, C₁-C₈-alkoxy or C₁-C₈-acyloxy groups, where at least one of the V, Y, Z radicals is a C₁-C₈-alkoxy or C₁-C₈-acyloxy group, and
n is 0 or 1.

The above silane-modified polymer having at least one end group of the general formula (I) is preferably a polyether or a poly(meth) acrylic ester.

A polyether is understood to mean a polymer, the organic repeat units of which contain ether functionalities (—C—O—C—) in the main chain. The polyethers thus do not include polymers having pendant ether groups, for example the cellulose ethers, starch ethers and vinyl ether polymers. Polyacetals such as polyoxymethylene (POM) are generally not counted among the polyethers either.

A poly(meth) acrylic ester is understood to mean a polymer based on (meth)acrylic esters, which therefore has, as repeat unit, the structural motif

—CH₂—CR^{a}(COOR^{b})— in which
R^{a} is a hydrogen atom (acrylic ester) or is a methyl group (methacrylic ester) and
R^{b} represents alkyl radicals that are linear, branched, cyclic and/or else contain functional substituents, for example methyl, ethyl, isopropyl, cyclohexyl, 2-ethylhexyl or 2-hydroxyethyl radicals.

More preferably in the context of the invention, the above silane-modified polymer having at least one end group of the general formula (I) is a polyether. Polyethers have a flexible and elastic structure which can be used to produce compositions having excellent elastic properties. At the same time, polyethers are not just flexible in their base structure but simultaneously stable. For example, polyethers are not attacked or broken down by water or bacteria, in contrast to polyesters for example.

Preferably, the number-average molecular weight Mₙ of the parent polyether of the above silane-modified polymer having at least one end group of the general formula (I) is 2000 to 100 000 g/mol (daltons), where the molecular weight is more preferably at least 6000 g/mol and especially at least 8000 g/mol. Number-average molecular weights of at least 2000 g/mol are advantageous for the polyethers in the context of the present invention because inventive compositions (KS) based on polyethers having such a minimum molecular weight have significant film-forming properties. For example, the number-average molecular weight Mₙ of the polyether is 4000 to 100 000, preferably 8000 to 50 000, more preferably 10 000 to 30 000, especially 17 000 to 27 000, g/mol. These molecular weights are particularly advantageous since the corresponding compositions (KS) have a balanced ratio of viscosity (ease of processibility), strength and elasticity. This combination is particularly advantageous within a molecular weight range from 18 000 to 26 000, especially from 20 000 to 24 000, g/mol.

Particularly advantageous viscoelastic properties can be achieved when polyethers having a narrow molar mass distribution and hence low polydispersity are used. These are preparable, for example, by what is called double metal cyanide catalysis (DMC catalysis). Polyethers prepared in this way are notable for a particularly narrow molar mass distribution, for a high average molar mass and for a very small number of double bonds at the ends of the polymer chains.

Preferably, the maximum polydispersity M_{w}/Mₙ of the parent polyether of the above silane-modified polymer having at least one end group of the general formula (I) is therefore 3, more preferably 1.7 and most preferably 1.5.

Molecular weight Mₙ is understood to mean the number-average molecular weight of the polymer. Just like the weight-average molecular weight M_{w} this is determined by gel permeation chromatography (GPC, also SEC) with polystyrene standard and tetrahydrofuran as eluent. This method is known to the person skilled in the art. Polydispersity derives from the average molecular weights M_{w} and Mₙ. It is calculated as PD=M_{w}/Mₙ. The ratio M_{w}/Mₙ (polydispersity) indicates the breadth of the molar mass distribution and hence of the possible degrees of polymerization of the individual chains in the case of polydisperse polymers. For many polymers and polycondensates, polydispersity has a value of about 2. There would be strict monodispersity if the value were 1. Low polydispersity of less than 1.5, for example, indicates a comparatively narrow molecular weight distribution and hence the specific extent of properties associated with molecular weight, for example viscosity. More particularly, therefore, in the context of the present invention, the parent polyether of the above silane-modified polymer having at least one end group of the general formula (I) has a polydispersity (M_{w}/Mₙ) of less than 1.3.

A divalent or bivalent binding group A containing at least one heteroatom is understood to mean a divalent chemical group that joins the polymer skeleton of the alkoxy- and/or acyloxysilane-terminated polymer to the R radical of the end group. The divalent binding group A may be formed, for example, in the preparation of the alkoxy- and/or acyloxysilane-terminated polymer, for example as amide or urethane group by the reaction of a polyether functionalized with hydroxyl groups with an isocyanatosilane. The bivalent binding group here may be either distinguishable or indistinguishable from structural features that occur in the parent polymer skeleton. The latter is the case, for example, when it is identical to the crosslinking points of the repeat units of the polymer skeleton.

The index “n” corresponds to 0 (zero) or 1, meaning that the divalent binding group A joins the polymer base skeleton to the R radical (n=1) or the polymer skeleton is bonded or linked directly to the R radical (n=0).

Preferably, the divalent binding group A in the general formula (I) is an oxygen atom or a —NR′— group in which R′ is a hydrogen atom or an alkyl or aryl radical having 1 to 12 carbon atoms, or the divalent binding group A contains an amide, carbamate, urea, imino, carboxylate, carbamoyl, amidino, carbonate, sulfonate or sulfinate group.

Particularly preferred binding groups A are urethane and urea groups that can be obtained by reaction of particular functional groups of a prepolymer with an organic silane bearing a further functional group. Urethane groups may form, for example, either when the polymer skeleton contains terminal hydroxyl groups and isocyanatosilanes are used as further components or when, conversely, a polymer having terminal isocyanate groups is reacted with an alkoxysilane containing terminal hydroxyl groups. In a similar manner, urea groups may be obtained when a terminal primary or secondary amino group—either on the silane or on the polymer—that reacts with a terminal isocyanate group present in the respective coreactant is used. This means that either an aminosilane is reacted with a polymer having terminal isocyanate groups or a polymer having terminal substitution by an amino group is reacted with an isocyanatosilane.

Urethane and urea groups advantageously increase the strength of the polymer chains and of the overall crosslinked polymer.

The R radical is a divalent hydrocarbyl radical having 1 to 12 carbon atoms. The hydrocarbyl radical may be a straight-chain, branched or cyclic alkyl radical. The hydrocarbyl radical may be saturated or unsaturated. R is preferably a divalent hydrocarbyl radical having 1 to 6 carbon atoms. It is possible to influence the curing rate of the composition via the length of the hydrocarbyl radicals that form one of the binding elements or the binding element between polymer skeleton and silyl radical. More preferably, R is a methylene, ethylene or n-propylene group, especially a methylene or n-propylene radical. Alkoxysilane-terminated compounds having a methylene group as binding element to the polymer skeleton—called α-silanes—have particularly high reactivity of the concluding silyl group, which leads to shortened setting times and hence to very rapid curing of formulations based on such polymers.

In general, an extension of the connecting hydrocarbon chain leads to reduced reactivity of the polymers. Particularly the γ-silanes—containing the unbranched propylene radical as binding element—have a balanced ratio between necessary reactivity (acceptable curing times) and delayed curing (open time, possibility of correction after bonding). By deliberately combining α- and γ-alkoxysilane-terminated units, it is thus possible to influence the curing rate of the systems as desired. The substituents V, Y and Z bonded directly to the silicon atom are independently C₁-C₈-alkyl radicals, C₁-C₈-alkoxy radicals or C₁-C₈-acyloxy radicals. At least one of the V, Y, Z radicals here must be a hydrolyzable group, i.e. a C₁-C₈-alkoxy radical or a C₁-C₈-acyloxy radical. Hydrolyzable groups chosen are preferably alkoxy groups, especially methoxy, ethoxy, i-propyloxy and i-butyloxy groups. This is advantageous since none of the substances that irritate the mucous membranes are released in the course of curing of compositions containing alkoxy groups. The alcohols formed by hydrolysis of the radicals are of no concern in the amounts released, and evaporate. Such compositions are therefore especially suitable for the DIY sector. However, hydrolyzable groups used may also be acyloxy groups, for example an acetoxy group —O—CO—CH₃.

The alkoxy- and/or acyloxysilane-terminated polymer(s) preferably has/have at least two end groups of the general formula (I). Each polymer chain thus contains at least two linkage sites at which the condensation of the polymers can proceed with elimination of the hydrolyzed radicals in the presence of air humidity. In this way, regular and rapid crosslinkability is achieved, such that it is possible to obtain adhesive bonds having good strengths. Furthermore, the configuration of the network achievable as a long-chain system (thermoplastics), as a relatively wide-mesh three-dimensional network (elastomers) or as a highly crosslinked system (thermosets) can be controlled via the amount and structure of hydrolyzable groups—for example by use of di- or trialkoxysilyl groups, methoxy groups or longer radicals—such that it is thus possible to influence properties including elasticity, functionality and heat resistance of the ready-crosslinked compositions.

In general, polymers containing di- or trialkoxysilyl groups have highly reactive crosslinking sites that enable rapid curing, high degrees of crosslinking and hence good final strengths. The particular advantage of dialkoxysilyl groups is that the corresponding compositions after curing are more elastic, softer and more flexible than systems containing trialkoxysilyl groups. They are therefore especially suitable for use as sealants. Furthermore, they release even less alcohol in the course of curing and are therefore of particular interest when the amount of alcohol released is to be reduced.

With trialkoxysilyl groups, in contrast, it is possible to achieve a higher degree of cross linking, which is particularly advantageous when a harder, firmer mass is desired after curing. Furthermore, trialkoxysilyl groups are more reactive, i.e. crosslink more quickly and hence lower the amount of catalyst required, and they have advantages in terms of “cold flow”—the dimensional stability of a corresponding adhesive under the influence of force and possibly high temperature.

More preferably, the V, Y and Z radicals in the general formula (I) are each independently a methyl group, an ethyl group, a methoxy group or an ethoxy group, where at least one of the radicals is a methoxy or ethoxy group. Methoxy and ethoxy groups, being comparatively small hydrolyzable groups having low steric demands, are very reactive and hence enable rapid curing even when a small amount of catalyst is used. They are therefore of particular interest for systems where rapid curing is desired, for example in the case of adhesives that are to have high initial bond strength.

More preferably, V, Y and Z are each independently a methyl group or a methoxy group, where at least one of the radicals is a methoxy group. Compounds having alkoxysilyl groups, according to the nature of the alkyl radicals on the oxygen atom, have different reactivities in chemical reactions. Among the alkoxy groups, it is the methoxy group that shows the greatest reactivity. It is thus possible to make use of such silyl groups when particularly rapid curing is desired. Higher aliphatic radicals such as ethoxy result in reactivity of the terminal alkoxysilyl group that is already lower compared to methoxy groups, and may be used advantageously to develop graded rates of crosslinking.

Likewise more preferably, V is an alkyl group and Y and Z are each independently an alkoxy group, or V, Y and Z are each independently an alkoxy group.

Configuration options of interest are also opened up by combinations of the two groups. If, for example, methoxy is chosen for V and ethoxy for Y within the same alkoxysilyl group, it is possible to particularly finely adjust the desired reactivity of the ultimate silyl groups if silyl groups bearing exclusively methoxy groups are perceived as being too reactive and the silyl groups bearing ethoxy groups as being too unreactive for the end use.

As well as methoxy and ethoxy groups, it is of course also possible to use larger radicals as hydrolyzable groups that naturally have lower reactivity. This is of interest particularly when delayed curing is to be achieved via the configuration of the alkoxy groups.

Mention should additionally be made of commercially available silane-modified polymers, especially products with the trade names MS Polymer™ (from Kaneka Corp.; especially the S203H, S303H, S227, S810, MA903 or S943 grades); MS Polymer™ or Silyl™ (from Kaneka Corp.; especially the SAT010, SAT030, SAT200, SAX350, SAX400, SAX725, MAX450, MAX602 or MAX951 grades); Excestar® (from Asahi Glass Co. Ltd.; especially the S2410, S2420, S3430 or S3630 grades); SPUR+* (from Momentive Performance Materials; especially the 1015LM or 1050MM grades); Vorasil™ (from Dow Chemical Co.; especially the 602 or 604 grades); Desmoseal® S (from Covestro Deutschland AG; especially the S XP 2458, S XP 2636, S XP 2749, S XP 2774 or S XP 2821 grades); TEGOPAC® (from Evonik Industries AG; especially the Seal 100, Bond 150 or Bond 250 grades); or Geniosil STP (from Wacker Chemie AG; especially the E15, E35, E10, E30 grades).

The proportion of the total amount of the above silane-modified polymer having at least one end group of the general formula (I) in the composition based on silane-modified polymers (KS) is preferably 5 to 75 percent by weight, more preferably 10 to 50 percent by weight, for example 12 to 35 percent by weight, especially 15 to 25 percent by weight, based in each case on the total weight of the composition (KS).

In addition, the compositions based on silane-modified polymers (KS) may also contain further constituents, for example plasticizers, catalysts, fillers, reactive diluents, desiccants and adhesion promoters, and auxiliaries.

The plasticizer is preferably selected from dialkyl cyclohexanedicarboxylates in which the alkyl radicals of the ester groups each independently contain 1 to 20 carbon atoms, preferably diisononyl cyclohexane-1,2-dicarboxylate, also referred to as DINCH, another dicarboxylic ester, fatty acid ester, an ester of fatty acids that bear OH groups or have been epoxidized, a fat, a glycolic ester, a benzoic ester, a phosphoric ester, a sulfonic ester, a trimellitic ester, an epoxidized plasticizer, a polyether plasticizer, a polystyrene, a hydrocarbon plasticizer and a chlorinated paraffin, and mixtures of two or more of these. By virtue of the specific selection of one of these plasticizers or of a specific combination, it is possible to achieve further advantageous properties of the composition of the invention, for example gelation capacity of the polymers, cold elasticity or cold stability, or else antistatic properties.

Among the polyether plasticizers, preference is given to using end group-capped polyethylene glycols, for example polyethylene or polypropylene glycol di-C₁-C₄-alkyl ethers, especially the dimethyl or diethyl ethers of diethylene glycol or dipropylene glycol, and mixtures of two or more of these. Likewise suitable as plasticizers are, for example, esters of abietic acid, butyric esters, acetic acid, propionic esters, thiobutyric esters, citric esters, and esters based on nitrocellulose and polyvinylacetate, and mixtures of two or more of these. Other suitable examples are the asymmetric esters of monooctyl adipate with 2-ethylhexanol (Edenol DOA, from Cognis Deutschland GmbH, Dusseldorf). Further suitable plasticizers are the pure or mixed ethers of monofunctional, linear or branched C₄-C₈ alcohols or mixtures of two or more different ethers of such alcohols, for example dioctyl ethers (available as Cetiol OE, from Cognis Deutschland GmbH, Dusseldorf). Likewise suitable as plasticizers in the context of the present invention are diurethanes, which can be prepared, for example, by the reaction of diols having OH end groups with monofunctional isocyanates, by choosing the stoichiometry such that essentially all the free OH groups react. Any excess isocyanate can subsequently be removed from the reaction mixture, for example by distillation. A further method of preparing diurethanes is that of reacting monofunctional alcohols with diisocyanates, with reaction of virtually all NCO groups.

In principle, it is also possible to use pthalic esters as plasticizers, but these are not preferred owing to their toxicological potential.

An excessively high viscosity of the compositions based on silane-modified polymers (KS) for particular applications can also be reduced in a simple and appropriate manner by using a reactive diluent, without occurrence of separation phenomena (for example plasticizer migration) in the cured mass. Preferably, the reactive diluent has at least one functional group that reacts, for example, with humidity or atmospheric oxygen after application. Examples of such groups are silyl groups, isocyanate groups, vinylically unsaturated groups and polyunsaturated systems. Reactive diluents used may be all compounds that are miscible with the composition based on silane-modified polymers (KS) with decreasing viscosity and have at least one group reactive with the binder, alone or as a combination of multiple compounds. The viscosity of the reactive diluent is preferably less than 20 000 mPas, more preferably about 0.1-6.000 mPas, most preferably 1-1000 mPas (Brookfield RVT, 23° C., spindle 7, 10 rpm).

Reactive diluents used may, for example, be the following substances: polyalkylene glycols reacted with isocyanatosilanes (for example Synalox 100-50B, DOW), alkyltrimethoxysilane, alkyltriethoxysilane, such as methyltrimethoxysilane, methyltriethoxysilane and vinyltrimethoxysilane (XL 10, Wacker), phenyltrimethoxysilane, phenyltriethoxysilane, octyltrimethoxysilane, tetraethoxysilane, vinyldimethoxymethylsilane (XL12, Wacker), vinyltriethoxysilane (GF56, Wacker), vinyltriacetoxysilane (GF62, Wacker), isooctyltrimethoxysilane (IO Trimethoxy), isooctyltriethoxysilane (IO Triethoxy, Wacker), N-trimethoxysilylmethyl O-methylcarbamate (XL63, Wacker), N-dimethoxy(methyl)silylmethyl O-methylcarbamate (XL65, Wacker), hexadecyltrimethoxysilane, 3-octanoylthio-1-propyltriethoxysilane and partial hydrolyzates of these compounds. The following polymers from Kaneka Corp. are also likewise usable as reactive diluents: MS S203H, MS S303H, MS SAT 010, and MS SAX 350.

Also suitable as reactive diluents are polymers preparable from an inorganic base skeleton by grafting with a vinylsilane or by reaction of polyol, polyisocyanate and alkoxysilane.

A polyol is understood to mean a compound containing one or more OH groups in the molecule. The OH groups may be either primary or secondary.

The suitable aliphatic alcohols include, for example, ethylene glycol, propylene glycol and higher glycols, and other polyfunctional alcohols. The polyols may additionally contain further functional groups, for example esters, carbonates, amides.

For preparation of a reactive diluent by reaction of polyol with polyisocyanate and alkoxysilane, the appropriate polyol component is reacted with at least one difunctional isocyanate in each case. A useful at least difunctional isocyanate is in principle any isocyanate having at least two isocyanate groups, but preference is generally given to compounds having two to four isocyanate groups, especially having two isocyanate groups, for compositions based on silane-modified polymers (KS).

Among the alkoxysilyl groups, preference is given to the di- and trialkoxysilyl groups. Suitable polyisocyanates for preparation of a reactive diluent include, for example, ethylene diisocyanate, tetramethylene 1,4-diisocyanate, tetramethoxybutane 1,4-diisocyanate, hexamethylene 1,6-diisocyanate (HDI), cyclobutane 1,3-diisocyanate, cyclohexane 1,3- and 1,4-diisocyanate, bis(2-isocyanatoethyl) fumarate, and mixtures of two or more of these, 1-isocyanato-3,3,5-trimethyl-5-isocyanatomethylcyclohexane (isophorone diisocyanate, IPDI), hexahydrotolylene 2,4- and 2,6-diisocyanate, hexahydrophenylene 1,3- or -1,4-diisocyanate, benzidine diisocyanate, naphthalene 1,5 -diisocyanate, 1,6-diisocyanato-2,2,4-trimethylhexane, 1,6-diisocyanato-2,4,4-trimethylhexane, xylylene diisocyanate (XDI), tetramethylxylylene diisocyanate (TMXDI), phenylene 1,3- and 1,4-diisocyanate, tolylene 2,4- or 2,6-diisocyanate (TDI), diphenylmethane 2,4′-diisocyanate, diphenylmethane 2,2′-diisocyanate or diphenylmethane 4,4′-diisocyanate (MDI) or the partially or fully hydrogenated cycloalkyl derivatives thereof, for example fully hydrogenated MDI (H12-MDI), alkyl-substituted diphenylmethane diisocyanates, for example mono-, di-, tri- or tetraalkyldiphenylmethane diisocyanates and the partially or fully hydrogenated cycloalkyl derivatives thereof, 4,4′-diisocyanatophenylperfluoroethane, bis(isocyanatoethyl) phthalate, 1-chloromethylphenyl 2,4- or 2,6-diisocyanate, 1-bromomethylphenyl 2,4- or 2,6-diisocyanate, 3,3-bis(chloromethyl) ether diphenyl 4,4′-diisocyanate, sulfur-containing diisocyanates as obtained by reaction of 2 mol of diisocyanate with 1 mol of thiodiglycol or dihydroxydihexyl sulfide, the di- and triisocyanates of the di- and trimer fatty acids, or mixtures of two or more of the diisocyanates mentioned.

Polyisocyanates used may likewise be trifunctional or higher-functional isocyanates as obtainable, for example, by oligomerizing diisocyanates, especially by oligomerizing the abovementioned isocyanates. Examples of such trifunctional and higher-functional polyisocyanates are the triisocyanurates of HDI and IPDI or mixtures thereof or mixed triisocyanurates thereof, and polyphenylmethylene polyisocyanate, as obtainable by phosgenation of aniline-formaldehyde condensation products.

The viscosity of the compositions based on silane-modified polymers (KS) can be reduced by also using solvents as well as or in place of a reactive diluent. Suitable solvents are aliphatic or aromatic hydrocarbons, halogenated hydrocarbons, alcohols, ketones, ethers, esters, ester alcohols, keto alcohols, keto ethers, keto esters and ether esters. However, preference is given to using alcohols since storage stability rises in this case. C₁-C₆ alcohols, particularly methanol, ethanol, i-propanol, isoamyl alcohol and hexanol, are particularly preferred. The composition of the invention may also comprise an adhesion promoter. An adhesion promoter is understood to mean a substance which improves the adhesion properties of adhesive layers on surfaces. Customary adhesion promoters (tackifiers) known to those skilled in the art may be used alone or as a combination of two or more compounds. Suitable examples include resins, terpene oligomers, coumarone/indene resins, aliphatic, petrochemical resins and modified phenol resins. Suitable examples in the context of the present invention include hydrocarbon resins as obtained by polymerization of terpenes, primarily α- or β-pinene, dipentene or limonene. These monomers are generally polymerized cationically with initiation by Friedel-Crafts catalysts. The terpene resins also include copolymers of terpenes and other monomers, for example styrene, a-methylstyrene, isoprene and the like. The resins mentioned are used, for example, as adhesion promoters for pressure-sensitive adhesives and coating materials. Likewise suitable are the terpene-phenol resins produced by acid-catalyzed addition of phenols onto terpenes or rosin. Terpene -phenol resins are soluble in most organic solvents and oils and are miscible with other resins, waxes and rubber. Adhesion promoters in the abovementioned sense which are likewise suitable within the context of the present invention are rosins and derivatives thereof, for example the esters or alcohols thereof. Silane adhesion promoters, especially aminosilanes, are of particularly good suitability.

In a specific embodiment within the scope of the invention, the compositions based on silane-modified polymers (KS) comprise a silane of the general formula (II) as adhesion promoter

R¹R²N—R³—SiV′Y′Z′ (II) in which
R¹ and R² are independently hydrogen or C₁-C₈-alkyl radicals,
R³ is a divalent hydrocarbyl radical optionally containing a heteroatom and having 1-12 carbon atoms, and
V′, Y′, Z′ are each independently C₁-C₈-alkyl, C₁-C₈-alkoxy or C₁-C₈-acyloxy radicals, where at least one of the V′, Y′, Z′ radicals is a C₁-C₈-alkoxy or C₁-C₈-acyloxy group.

Such compounds naturally have a high affinity for the binding polymer components of the composition based on silane-modified polymers (KS), but also for a wide range of polar and nonpolar surfaces, and therefore contribute to the formation of a particularly stable bond between the adhesive composition and the respective substrates to be bonded.

The binding group R³ may, for example, be a straight-chain or branched or cyclic, substituted or unsubstituted alkylene radical. It may contain nitrogen (N) or oxygen (O) as heteroatom. When V′, Y′ and/or Z′ is an acyloxy group, this may be, for example, the acetoxy group —OCO—CH₃.

One or more adhesion promoters is/are preferably present in the compositions based on silane-modified polymers (KS) to an extent of 0.1 to 5 percent by weight, more preferably to an extent of 0.2 to 2 percent by weight, especially to an extent of 0.3 to 1 percent by weight, based in each case on the total weight of the composition.

The compositions based on silane-modified polymers (KS) may comprise a catalyst for the crosslinking of the silane-functional polymers by means of moisture. These are known to those skilled in the art. Such catalysts are especially metal catalysts in the form of organotin compounds such as dibutyltin dilaurate and dibutyltin diacetylacetonate, titanium catalysts, compounds containing amino groups, for example 1,4-diazabicyclo [2.2.2]octane and 2,2′-dimorpholinodiethyl ether, aminosilanes and mixtures of the catalysts mentioned. Preference is given to using compounds containing amino groups.

Examples of suitable fillers for the compositions based on silane-modified polymers (KS) are chalk, powdered lime, precipitated and/or fumed silica, zeolites, bentonites, magnesium carbonate, kieselguhr, alumina, clay, talc, titanium oxide, iron oxide, zinc oxide, sand, quartz, flint, mica, glass powder and other ground mineral materials. In addition, organic fillers can also be used, in particular carbon black, graphite, wood fibers, wood flour, wood shavings, cellulose, cotton, pulp, wood chips, chopped straw, chaff, ground walnut shells and other short-cut fibers. Short fibers such as glass fiber, glass filament, polyacrylonitrile, carbon fiber, Kevlar fiber or polyethylene fibers can also be added. Aluminum powder is likewise suitable as a filler. In addition, hollow spheres with a mineral shell or a plastics shell are suitable as fillers. These can, for example, be hollow glass spheres which are commercially available under the trade names Glass Bubbles®.

Plastic-based hollow spheres are commercially available, for example, under the names Expancel® or Dualite®. These are composed of inorganic or organic materials, each with a diameter of 1 mm or less, preferably of 500 μm or less. For some applications, preference is given to fillers that impart thixotropic properties to the formulations. Such fillers are also referred to as rheological auxiliaries, for example hydrogenated castor oil, fatty acid amides or swellable plastics such as PVC. In order that they can be efficiently expressed from a suitable metering device (for example tube), such formulations have a viscosity of 3000 to 15 000, preferably 4000 to 8000, mPas, or else 5000 to 6000 mPas.

The fillers are preferably used in an amount of 1 to 75 percent by weight, more preferably of 10 to 70 percent by weight, likewise preferably of 25 to 60 percent by weight and especially preferably of 35 to 55 percent by weight, based on the total weight of the composition based on silane-modified polymers (KS). It is possible to use a single filler or a combination of multiple fillers.

For example, the filler used is a finely divided silica having a BET surface area of 10 to 500 m²/g. When used, such a silica does not bring about any substantial increase in the viscosity of the composition based on silane-modified polymers (KS), but it does contribute to a strengthening of the cured preparation. This reinforcement, for example, improves initial strengths, lap shear strengths and adhesion of the adhesives, sealants or coatings in which the composition based on silane-modified polymers (KS) is used. Preference is given to using uncoated silicas having a BET surface area of less than 100, more preferably of less than 65 m²/g, and/or coated silicas having a BET surface area of 100 to 400, more preferably of 100 to 300, especially of 150 to 300 and very particularly preferably of 200 to 300 m²/g.

Zeolites used are preferably alkali metal aluminosilicates, for example sodium potassium aluminosilicates of the general empirical formula aK₂O*bNa₂O*Al₂O₃*2SiO*nH₂O with 0<a, b<1 and a+b=1. The pore opening of the zeolite used or of the zeolites used is preferably just large enough to accommodate water molecules. Accordingly, an effective pore opening of the zeolites of less than 0.4 nm is preferred. The effective pore opening is more preferably 0.3 nm±0.02 nm. The zeolite(s) is/are preferably used in the form of a powder.

Chalk is preferably used as filler. The chalk used here may be cubic, non-cubic, amorphous and other polymorphs of calcium carbonate.

The chalks used are preferably surface-treated or coated. Coating compositions used are preferably fatty acids, fatty acid soaps and fatty acid esters, for example lauric acid, palmitic acid or stearic acid, sodium or potassium salts of such acids or the alkyl esters thereof. In addition, however, other surface-active substances such as sulfate esters of long-chain alcohols or

alkylbenzenesulfonic acids or the sodium or potassium salts thereof or else coupling reagents based on silanes or titanates are also useful. The surface treatment of the chalks is frequently associated with an improvement in processibility, and in bonding force and also weather resistance of the compositions. The coating composition is typically used in a proportion of 0.1 to 20 percent by weight, preferably 1 to 5 percent by weight, based on the total weight of the untreated chalk

Depending on the profile of properties sought, precipitated or ground chalks or mixtures thereof may be used. Ground chalks may for example be produced from natural lime, limestone or marble by mechanical grinding, with dry or wet methods possibly being used. Depending on the grinding method, fractions of different average particle size are obtained. Advantageous specific surface area values (BET) are between 1.5 m²/g and 50 m²/g.

In addition, the composition based on silane-modified polymers (KS) may contain antioxidants. The proportion of antioxidants in the composition based on silane-modified polymers (KS) is preferably up to 7 percent by weight, especially up to 5 percent by weight, based in each case on the total weight of the composition.

The composition based on silane-modified polymers (KS) may additionally contain UV stabilizers. The proportion of UV stabilizers in the composition based on silane-modified polymers (KS) is preferably up to 2 percent by weight, especially up to 1 percent by weight. Particularly suitable UV stabilizers are those known as hindered amine light stabilizers (HALS). Preference is given to using a UV stabilizer that bears a silyl group and is incorporated into the end product on crosslinking or curing. Particularly suitable products for this purpose are Lowilite 75, Lowilite 77 (from Great Lakes, USA). In addition, it is also possible to add benzotriazoles, benzophenones, benzoates, cyanoacrylates, acrylates, sterically hindered phenols, phosphorus and/or sulfur.

It is frequently advisable to stabilize the composition based on silane-modified polymers (KS) further against penetrating moisture in order to even further increase shelf life. Such an improvement in shelf life can be achieved, for example, by the use of desiccants. Suitable desiccants are all compounds that react with water to form a group that is inert toward the reactive groups present in the composition, and undergo minimum changes in their molecular weight as they do so. In addition, the reactivity of the desiccants with respect to the moisture penetrating into the composition must be higher than the reactivity of the end groups of the polymer bearing silyl groups which is present in the composition. Examples of suitable desiccants include isocyanates.

Desiccants used are advantageously also silanes, for example vinylsilanes such as 3-vinylpropyltriethoxysilane, oxime silanes such as methyl-O,O′,O″-butan-2-one trioximosilane or O,O′,O″,O′″-butan-2-one tetraoximosilane (CAS No. 022984-54-9 and 034206-40-1) or benzamidosilanes such as bis(N-methylbenzamido)methylethoxysilane (CAS No. 16230-35-6) or carbamatosilanes such as carbamatomethyltrimethoxysilane. But it is also possible to use methyl-, ethyl- or vinyltrimethoxysilane, tetramethyl- or -ethylethoxysilane. Particular preference is given here to vinyltrimethoxysilane and tetraethoxysilane in respect of efficiency and costs. Likewise suitable as desiccants are the abovementioned reactive diluents, provided that they have a molecular weight (Mₙ) of less than about 5000 g/mol and have end groups having reactivity toward penetrating moisture which is at least equal to and preferably greater than the reactivity of the reactive groups of the polymer of the invention bearing silyl groups. Finally, desiccants used may also be alkyl orthoformates or orthoacetates, for example methyl or ethyl orthoformate, methyl or ethyl orthoacetate. The composition based on silane-modified polymers (KS) preferably contains 0.01 to 10 percent by weight of desiccants, based on the total weight of the composition.

The composition based on silane-modified polymers (KS) preferably contains the following constituents in the proportions by weight specified:

5-75 percent by weight of at least one silane-modified polymer having at least one end group of the general formula (I)

5-75 percent by weight of filler

5-35 percent by weight of plasticizer

0.01-1 percent by weight of catalyst

where the proportions by weight add up to 100 percent by weight and the proportions by weight are based on the total weight of composition based on silane-modified polymers (KS).

Auxiliaries present in the composition based on silane-modified polymers (KS), over and above the constituents already detailed, may include, for example, stabilizers, UV stabilizers, aging stabilizers, rheological auxiliaries, color pigments or pastes, fungicides, flame retardants and/or optionally also solvents to a minor degree.

The composition based on silane-modified polymers (KS) is produced by known methods by intimate mixing of the constituents in suitable dispersing units, for example a high-speed mixer.

The composition based on silane-modified polymers (KS) may of course also be used as sealant rather than as adhesive.

It will be appreciated that, in the selection of the composition based on silane-modified polymers (KS), it is also possible to make use of already commercially available products that are sold under the SMP, STP or else hybrid adhesive name.

One-component (1K) coating compositions containing a self-crosslinking polyacrylate dispersion as binder have long been known. They are suitable for the production of high-quality coatings that can be tailored to make them hard, elastic, resistant to abrasion and chemicals and, in particular, also stable to weathering.

In the context of the present invention, that of the layer structure of primer layer (G) obtainable from polyacrylate primer (AG) and composition based on silane-modified polymers (KS), the polyacrylate primer (AG) is in the form of an aqueous polymer dispersion, where this aqueous polymer dispersion contains water-dispersed polymer particles preparable by free-radical polymerization of monomers comprising
a) at least 50 percent by weight, based on the total amount of monomers, of at least one monomer selected from the group consisting of C₁- to C₂₀-alkyl acrylates, C₁- to C₂₀-alkyl methacrylates, vinyl esters of carboxylic acids containing up to 20 carbon atoms, vinylaromatics having up to 20 carbon atoms, vinyl halides, vinyl ethers of alcohols containing 1 to 10 carbon atoms, aliphatic hydrocarbons having 2 to 8 carbon atoms and one or two double bonds, and mixtures of these monomers, and
b) at least 0.1 percent by weight, based on the total amount of monomers, of at least one monomer having at least one acid group, and
c) at least 0.1 to 5 percent by weight, based on the total amount of monomers, of at least one ethylenically unsaturated compound having at least one functional group selected from keto groups and aldehyde groups,
   wherein the aqueous polymer dispersion, in addition to the water-dispersed polymer particles, contains at least one compound AH having at least two functional groups that can enter into a crosslinking reaction with the keto groups or with the aldehyde groups,
   where the molar ratio of the groups in compound AH that are reactive with keto groups or with aldehyde groups to the keto and aldehyde groups in monomer b) is from 1:10 to 2:1,
d) optionally further monomers d.

The polymer dispersions for use in accordance with the invention (polyacrylate primers (AG)) are obtainable by free-radical emulsion polymerization of ethylenically unsaturated, free-radically polymerizable compounds (monomers). The polymerization is preferably effected without emulsifier or with a low emulsifier level, in that less than 1 part by weight of emulsifier or less than 0.8 part by weight, preferably not more than 0.5 part by weight of emulsifier, based on 100 parts by weight of monomers, is added for stabilization of the polymer dispersion of the invention. Emulsifiers are nonpolymeric amphiphilic surface-active substances that are added to the polymerization mixture before or after the polymerization. Small amounts of emulsifiers resulting from the use of emulsifier-stabilized polymer seed, for example, are harmless. It is also possible to use in total less than 0.3 part by weight or less than 0.2 part by weight of emulsifier, for example from 0.05 to less than 1 part by weight, from 0.05 to less than 0.8 part by weight, from 0.05 to 0.5 part by weight, or from 0.05 to 0.3 part by weight, based on 100 parts by weight of monomers, or no emulsifier.

A detailed description of suitable protective colloids can be found in Houben-Weyl, Methoden der organischen Chemie [Methods of Organic Chemistry], volume XIV/1, Makromolekulare Stoffe [Macromolecular Substances], Georg-Thieme-Verlag, Stuttgart, 1961, p. 411 to 420. Useful emulsifiers include anionic, cationic and nonionic emulsifiers. Interface-active substances used are preferably emulsifiers having a molecular weight which, by contrast with the protective colloids, is typically below 2000 g/mol. When mixtures of interface-active substances are used, the individual components must of course be compatible with one another, which can be verified in the case of doubt by a few preliminary tests. Preference is given to using anionic and nonionic emulsifiers as interface-active substances. Commonly used accompanying emulsifiers are, for example, ethoxylated fatty alcohols (EO level: 3 to 50, alkyl radical: C₈- to C₃₆-alkyl), ethoxylated mono-, di- and trialkylphenols (EO level: 3 to 50, alkyl radical: C₄- to C₉-alkyl), alkali metal salts of dialkyl esters of sulfosuccinic acid and alkali metal and ammonium salts of alkyl sulfates (alkyl radical: C₈- to C₁₂-alkyl), of ethoxylated alkanols (EO level: 4 to 30, alkyl radical: C₁₂- to C₁₈-alkyl), of ethoxylated alkylphenols (EO level: 3 to 50, alkyl radical: C₄- to C₉-alkyl), of alkylsulfonic acids (alkyl radical: C₁₂- to C₁₈-alkyl) and of alkylarylsulfonic acids (alkyl radical: C₉- to C₁₈-alkyl).

Further suitable emulsifiers are compounds of the general formula

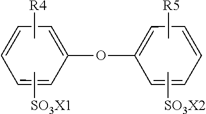

in which R4 and R5 are hydrogen or C₄- to C₁₄-alkyl and are not both hydrogen, and X1 and X2 may be alkali metal ions and/or ammonium ions. Preferably, R4 and R5 are linear or branched alkyl radicals having 6 to 18 carbon atoms or hydrogen and especially having 6, 12 and 16 carbon atoms, where R4 and R5 are not both simultaneously hydrogen. X1 and X2 are preferably sodium, potassium or ammonium ions, particular preference being given to sodium. Particularly advantageous compounds are those in which X1 and X2 are sodium, R4 is a branched alkyl radical having 12 carbon atoms and R5 is hydrogen or R4. Technical grade mixtures having a proportion of 50 to 90 percent by weight of the monoalkylated product are frequently used. Commercial products of suitable emulsifiers are, for example, Dowfax® 2 A1, Emulan® NP 50, Dextrol® OC 50, Emulgator 825, Emulgator 825 S, Emulan® OG, Texapon® NSO, Nekanil® 904 S, Lumiten® 1-RA, Lumiten® E 3065, Disponil® FES 77, Lutensol® AT 18, Steinapol® VSL, Emulphor® NPS 25. Ionic emulsifiers or protective colloids are preferred. Particular preference is given to ionic emulsifiers, especially salts and acids, such as carboxylic acids, sulfonic acids and sulfates, sulfonates or carboxylates. In particular, it is also possible to use mixtures of ionic and nonionic emulsifiers.

The polymerization can also be effected in the presence of a protective colloid. Protective colloids are polymeric compounds that bind large amounts of water on solvation and are capable of stabilizing dispersions of water-insoluble polymers. By contrast with emulsifiers, they generally do not lower the interfacial tension between polymer particles and water. The number-average molecular weight of protective colloids is, for example, above 1000 g/mol.

Monomers a)

The monomer mixture consists of at least 50 to 90 percent by weight, preferably 80 to 90 percent by weight, based on the total amount of monomers a) to d), of at least one monomer a) selected from the group consisting of C₁- to C₂₀-alkyl acrylates, C₁- to C₂₀-alkyl methacrylates, vinyl esters of carboxylic acids containing up to 20 carbon atoms, vinylaromatics having up to 20 carbon atoms, vinyl halides, vinyl ethers of alcohols containing 1 to 10 carbon atoms, aliphatic hydrocarbons having 2 to 8 carbon atoms and one or two double bonds, and mixtures of these monomers.

Suitable monomers a) are, for example, alkyl (meth)acrylates having a C₁-C₁₀-alkyl radical, such as methyl methacrylate, methyl acrylate, n-butyl acrylate, ethyl acrylate and 2-ethylhexyl acrylate, and benzyl (meth)acrylate, isobutyl acrylate, tert-butyl (meth)acrylate and cyclohexyl (meth)acrylate. Also especially suitable are mixtures of the alkyl (meth)acrylates. Vinyl esters of carboxylic acids having 1 to 20 carbon atoms are, for example, vinyl laurate, vinyl stearate, vinyl propionate, vinyl versatate and vinyl acetate. Useful vinylaromatic compounds include vinyltoluene, alpha- and para-methylstyrene, alpha-butylstyrene, 4-n-butylstyrene, 4-n-decylstyrene and, preferably, styrene. The vinyl halides are ethylenically unsaturated compounds substituted by chlorine, fluorine or bromine, preferably vinyl chloride and vinylidene chloride. Examples of vinyl ethers include vinyl methyl ether or vinyl isobutyl ether. Preference is given to vinyl ethers of alcohols comprising 1 to 4 carbon atoms. Suitable hydrocarbons having 4 to 8 carbon atoms and two olefinic double bonds are butadiene, isoprene and chloroprene. Preferred monomers a) are the C₁- to C₁₀-alkyl acrylates and methacrylates, especially C₁- to C₈-alkyl acrylates and methacrylates, and styrene, and mixtures thereof. Particular preference is given to methyl acrylate, methyl methacrylate, ethyl acrylate, n-butyl acrylate, n-butyl methacrylate, n-hexyl acrylate, octyl acrylate, 2-ethylhexyl acrylate, 2-propylheptyl acrylate, styrene, and mixtures of these monomers. Very particular preference is given to styrene, methyl methacrylate and ethylhexyl acrylate.

Monomers b)

The monomer mixture consists to an extent of at least 0.1 percent by weight, preferably 0.1 to 5 percent by weight, more preferably 0.5 to 3.5 percent by weight and most preferably 2 to 4 percent by weight, based on the total amount of monomers a) to d), of at least one ethylenically unsaturated monomer having at least one acid group (acid monomer). The acid monomers d) include both monomers containing at least one acidic group and anhydrides thereof and salts thereof. The monomers b) include alpha,beta-monoethylenically unsaturated mono- and dicarboxylic acids, monoesters of alpha,beta-monoethylenically unsaturated dicarboxylic acids, the anhydrides of the aforementioned alpha,beta-monoethylenically unsaturated carboxylic acids and ethylenically unsaturated sulfonic acids, phosphonic acids or dihydrogenphosphates and water-soluble salts thereof, for example alkali metal salts thereof. Examples of these include acrylic acid, methacrylic acid, itaconic acid, maleic acid, fumaric acid, crotonic acid, vinylacetic acid and vinyllactic acid. Suitable ethylenically unsaturated sulfonic acids include, for example, vinylsulfonic acid, styrenesulfonic acid, acrylamidomethylpropanesulfonic acid, sulfopropyl acrylate and sulfopropyl methacrylate. Preferred monomers b) are alpha,beta-monoethylenically unsaturated C₃-C₈ carboxylic acids and C₄-C₈ dicarboxylic acids, e.g. itaconic acid, crotonic acid, vinyl acetic acid, acrylamidoglycolic acid, acrylic acid and methacrylic acid, and anhydrides thereof. Particularly preferred monomers b) are itaconic acid, acrylic acid and methacrylic acid, and mixtures thereof. A very particularly preferred monomer b) is acrylic acid.

Monomers c)

In the present invention, the polymer dispersion contains keto or aldehyde groups. The keto or aldehyde groups may be bonded to the polymer by copolymerization of suitable monomers c). The monomer mixture consists to an extent of 0.1 to 5 percent by weight, preferably to an extent of 0.2 to 5 percent by weight, more preferably to an extent of 1 to 3 percent by weight, based on the total amount of monomers a) to d), of ethylenically unsaturated monomers having at least one functional group selected from keto groups and aldehyde groups.

Monomers c) are, for example, acrolein, methacrolein, vinyl alkyl ketones having 1 to 20, preferably 1 to 10, carbon atoms in the alkyl radical, formylstyrene, alkyl (meth)acrylates having one or two keto or aldehyde groups, or one aldehyde and one keto group, in the alkyl radical, where the alkyl radical preferably comprises 3 to 10 carbon atoms in total, e.g. (meth)acryloyloxypropanals, as described, for example, in DE-A 2 722 097. Also additionally suitable are N-oxoalkyl(meth)acrylamides as known for example from DE-A 2 061 213 or DE-A 2 207 209, for example those of the formula R₆—C(═O)—R₇—NH—C(═O)—CR₈═CH₂ where R₆ and R₈ are independently hydrogen or a hydrocarbyl group (preferably alkyl) having 1 to 10 carbon atoms, and R₇ is a hydrocarbyl group (preferably alkylene) having 2 to 15 carbon atoms. Particular preference is given to acetoacetyl (meth)acrylate, acetoacetoxyethyl (meth)acrylate and especially diacetoneacrylamide.

Monomers d):

The monomer mixture may optionally contain at least one further monomer d) other than the monomers a) to c) with a proportion of 5 to 15 percent by weight, based on the total amount of monomers a) to d).

Monomers d) are, for example, uncharged or nonionic monomers having elevated water solubility, for example amides or the N-alkylolamides of the aforementioned carboxylic acids, for example acrylamide, methacrylamide, N-methylolmethacrylamide and N-methylmethacrylamide, or phenyloxyethylglycol mono(meth)acrylate. Further monomers d) are, for example, also monomers containing hydroxyl groups, especially the hydroxyalkyl esters of the aforementioned alpha,beta-monoethylenically unsaturated carboxylic acids, preferably C₁-C₁₀-hydroxyalkyl (meth)acrylates, for example hydroxyethyl acrylate, hydroxyethyl methacrylate, hydroxypropyl acrylate or hydroxypropyl methacrylate, and 4-hydroxybutyl acrylate. Further monomers d) are, for example, also monomers containing amino groups, especially the aminoalkyl esters of the aforementioned alpha,beta-monoethylenically unsaturated carboxylic acids, preferably C₁-C₁₀-aminoalkyl (meth)acrylates, for example 2-aminoethyl (meth)acrylate or tert-butylaminoethyl methacrylate. Further useful monomers d) are the nitriles of alpha,beta-monoethylenically unsaturated C₃-C₈ carboxylic acids, for example acrylonitrile or methacrylonitrile. Suitable monomers d) are also bifunctional monomers having, as well as an ethylenically unsaturated double bond, at least one glycidyl group, oxazoline group, ureido group or ureido analog group. Examples of monomers with a glycidyl group are ethylenically unsaturated glycidyl ethers and glycidyl esters, for example vinyl, allyl and methallyl glycidyl ethers and glycidyl (meth)acrylate. Examples of monomers d) are also crosslinking monomers having more than one free-radically polymerizable group, especially two or more (meth)acrylate groups, for example butanediol di(meth)acrylate or allyl methacrylate. Particularly preferred monomers d) are hydroxyalkyl (meth)acrylates having 1 to 10 carbon atoms in the alkyl group.

Compound AH

The dispersions to be used in the context of production of the layer structure of the invention also contain at least one compound AH having at least 2 functional groups, especially 2 to 5 functional groups, that enter into a crosslinking reaction with the keto or aldehyde groups. Compounds that can enter into a crosslinking reaction with the keto or aldehyde groups are, for example, compounds having hydrazide, hydroxylamine, oxime ether or amino groups. Suitable compounds having hydrazide groups are, for example, polycarboxylic hydrazides having a molar mass of preferably up to 500 g/mol. Preferred hydrazide compounds are dicarboxylic dihydrazides having preferably 2 to 10 carbon atoms. Suitable examples include oxalic dihydrazide, malonic dihydrazide, succinic dihydrazide, carbodihydrazide, glutaric dihydrazide, adipic dihydrazide, sebacic dihydrazide, maleic dihydrazide, fumaric dihydrazide, itaconic dihydrazide, and/or isophthalic dihydrazide. Particular preference is given to adipic dihydrazide, sebacic dihydrazide and isophthalic dihydrazide. Suitable compounds having amino groups are, for example, ethylenediamine, propylenediamine, tetramethylenediamine, pentamethylenediamine, hexamethylenediamine, diethylenetriamine, triethylenetetramine, polyethyleneimine, partly hydrolyzed polyvinylformamides, ethylene oxide and propylene oxide adducts of amines, such as the “Jeffamines”, cyclohexanediamine and xylylenediamine. The compound having the functional groups may be added to the composition or dispersion of the polymer at any time. There is no occurrence of crosslinking with the keto or aldehyde groups as yet in the aqueous dispersion. It is only in the course of drying that crosslinking on the coated substrate occurs.

The compound AH is preferably adipic dihydrazide, and monomer c) diacetoneacrylamide.

The amount of compound AH having functional groups reactive with keto or aldehyde groups is preferably such that the molar ratio of the functional groups reactive with keto or aldehyde groups to the keto and/or aldehyde groups of monomer b) is 1:10 to 2:1, especially 1:5 to 2:1, more preferably 1:2 to 2:1, more preferably 1:1.3 to 1.3:1 and most preferably 1:1.1 to 1.1:1. In particular, preference is given to equimolar amounts of the functional groups and of the keto and/or aldehyde groups.

The polymer particles of the polymer dispersion to be used in the context of production of the layer structure of the invention have preferably been produced from monomers comprising
a) 80 to 90 percent by weight, based on the total amount of monomers a)-d), of at least one monomer selected from the group consisting of styrene, methyl methacrylate and ethylhexyl acrylate and mixtures of these monomers, and
b) 2 to 4 percent by weight, based on the total amount of monomers a)-d), of acrylic acid and
c) 1 to 3 percent by weight, based on the total amount of monomers a)-d), of diacetoneacrylamide;
d) 5 to 15 percent by weight, based on the total amount of monomers a)-d), of hydroxyethyl methacrylate.

The monomers in the polymerization are preferably selected such that the glass transition temperature is in the range from −40° C. to +100° C., especially from −10° C. to +75° C. or from −10° C. to +60° C.

By controlled variation of the type and amount of monomers, it is possible in accordance with the invention for the person skilled in the art to produce aqueous polymer compositions, the polymers of which have a glass transition temperature within the desired range. Orientation is possible by means of the Fox equation. According to Fox (T. G. Fox, Bull. Am. Phys. Soc. 1956 [Ser. I I] 1, pages 123 and according to Ullmann's Encyclopadie der technischen Chemie [Ullmann's Encyclopedia of Industrial Chemistry], vol. 19, page 18, 4th edition, Verlag Chemie, Weinheim, 1980), a good approximation for calculation of the glass transition of copolymers is as follows:

1/Tg=XVTg1+X2/Tg2+ . . . X″/Tg″

where x1, x2, . . . xn are the mass fractions of monomers 1, 2, . . . n and Tg1, Tg2, Tg n are the glass transition temperatures of the polymers formed in each case solely from one of the monomers 1, 2, . . . n in degrees Kelvin. The Tg values for the homopolymers of most monomers are known and are listed, for example, in Ullmann's Encyclopedia of Industrial Chemistry, book 5, vol. A21, page 169, VCH Weinheim, 1992; further sources of glass transition temperatures of homopolymers are, for example, J. Brandrup, E.H. Immergut, Polymer Handbook, 1st ed., J. Wiley, New York 1966, 2nd ed. J. Wiley, New York 1975, and 3rd ed. J. Wiley, New York 1989.

In one embodiment of the layer structure of the invention, at least one chain transfer agent is used to control molecular weight in the polymerization for production of the polyacrylate primer (AG) in the form of an aqueous polymer dispersion. It is possible thereby to reduce the molar mass of the emulsion polymer by a chain termination reaction. The chain transfer agent is bound here to the polymer, generally to the chain end. The amount of the chain transfer agent is especially 0.05 to 4 parts by weight, more preferably 0.05 to 0.8 part by weight and most preferably 0.1 to 0.6 part by weight, based on 100 parts by weight of the monomers to be polymerized. Suitable chain transfer agents are, for example, compounds having a thiol group, such as tert-butyl mercaptan, ethylacryloyl thioglycolate, mercaptoethanol, mercaptopropyltrimethoxysilane or tert-dodecyl mercaptan. The chain transfer agents are generally low molecular weight compounds having a molar mass of less than 2000, especially less than 1000, g/mol. Preference is given to 2-ethylhexyl thioglycolate (EHTG), isooctyl 3-mercaptopropionate (IOMPA) and tert-dodecyl mercaptan (tDMK).

The polymerization is preferably effected in a seed-controlled manner, i.e. in the presence of polymer seed (seed latex). Seed latex is an aqueous dispersion of finely divided polymer particles having an average particle diameter of preferably 20 to 40 nm. Seed latex is used in an amount of preferably 0.01 to 0.5 part by weight, more preferably 0.03 to 0.3 part by weight, based on 100 parts by weight of monomers. A suitable example is a latex based on polystyrene or based on polymethylmethacrylate. A preferred seed latex is polystyrene seed. The polymer dispersion present in the layer structure of the invention is produced by emulsion polymerization. In the emulsion polymerization, ethylenically unsaturated compounds (monomers) are polymerized in water, typically using ionic and/or nonionic emulsifiers and/or protective colloids or stabilizers as interface-active compounds for stabilization of the monomer droplets and of the polymer particles formed later on from the monomers. Preferably, however, the polymerization is effected with a low emulsifier level and without addition or formation of protective colloids. The polymer dispersion formed can be stabilized by a specific procedure. This is based on a slow initial monomer feed in the presence of a very small amount of polymer seed (seed control), followed by the neutralization of the acid monomers used in the course of or after the polymerization.

Acid groups in the polymer are preferably neutralized by feeding in a neutralizing agent during or after the polymerization, while the acid groups are wholly or partly neutralized by feeding in a base. The neutralizing agent may be added, for example, in a separate feed parallel to the feed of the monomer mixture. After all the monomers have been fed in, the amount of neutralizing agent required to neutralize at least 10%, preferably 10% to 100% or 25% to 90%, of acid equivalents is preferably present in the polymerization vessel. The particularly preferred neutralizing agent is ammonia.

The emulsion polymerization can be initiated with water-soluble initiators. Water-soluble initiators are, for example, ammonium and alkali metal salts of peroxodisulfuric acid, e.g. sodium peroxodisulfate, hydrogen peroxide or organic peroxides, e.g. tert-butyl hydroperoxide. Also suitable as initiator are what are called reduction-oxidation (redox) initiator systems. The redox initiator systems consist of at least one, usually inorganic, reducing agent and an inorganic or organic oxidizing agent. The oxidation component comprises, for example, the initiators already mentioned above for the emulsion polymerization. The reduction component comprises, for example, alkali metal salts of sulfurous acid, for example sodium sulfite, sodium hydrogensulfite, alkali metal salts of disulfurous acid, such as sodium disulfite, bisulfite addition compounds of aliphatic aldehydes and ketones, such as acetone bisulfite, or reducing agents such as hydroxymethanesulfinic acid and salts thereof, or ascorbic acid. The redox initiator systems may be used with additional use of soluble metal compounds, the metallic component of which can occur in multiple valence states. Customary redox initiator systems are, for example, ascorbic acid/iron(II) sulfate/sodium peroxodisulfate, tert-butyl hydroperoxide/sodium disulfite, tert-butyl hydroperoxide/sodium hydroxymethanesulfinate. The individual components, for example the reduction component, may also be mixtures, for example a mixture of the sodium salt of hydroxymethanesulfinic acid and sodium disulfite. The initiators mentioned are usually used in the form of aqueous solutions, where the lower concentration is determined by the amount of water acceptable in the dispersion and the upper concentration by the solubility of the compound in question in water. In general, the concentration of the initiators is 0.1 to 30 percent by weight, preferably 0.5 to 20 percent by weight, more preferably 1.0 to 10 percent by weight, based on the monomers to be polymerized. It is also possible to use multiple different initiators in the emulsion polymerization.

The emulsion polymerization is preferably effected at 30 to 130° C., preferably at 50 to 90° C. The polymerization medium may consist either solely of water or of mixtures of water and liquids miscible therewith, such as methanol. Preference is given to using water only. The emulsion polymerization can be performed in the form of a feed process, including stage or gradient mode, for production of multiphase polymers, as described, for example, in EP2389397A1 and documents cited therein. In the polymerization, for better adjustment of the particle size, a polymer seed may be initially introduced.

The manner in which the initiator is added to the polymerization vessel over the course of the free-radical aqueous emulsion polymerization is known to the person of average skill in the art. It can either be fully included in the initial charge in the polymerization vessel or added continuously or stepwise according to its consumption in the course of the free-radical aqueous emulsion polymerization. Specifically, this depends on the chemical nature of the initiator system and on the polymerization temperature. Preference is given to including a portion in the initial charge and feeding in the rest according to the consumption in the polymerization zone. For removal of the residual monomers, it is customary to add initiator even after the end of the actual emulsion polymerization, i.e. after a conversion of the monomers of at least 95%. The individual components may be added to the reactor in the feed process from the top, at the side or from the bottom through the reactor base.

The emulsion polymerization generally affords aqueous dispersions of the polymer with solids contents of 15 to 75 percent by weight, preferably of 40 to 60 percent by weight, more preferably not less than 50 percent by weight.

The pH of the polymer dispersion is preferably adjusted to pH greater than 5, especially to a pH between 5.5 and 8.

Optionally, the polyacrylate primer (AG) may contain further substances, for example solvents, aqueous polyurethane dispersions, dispersions of silanized styrene-acrylate copolymers, vinylidene chloride polymers or acrylate-vinylidene chloride copolymers, paraffin waxes and further customary auxiliaries. Customary auxiliaries are, for example, wetting agents, thickeners, light stabilizers, biocides, defoamers etc.

The polyacrylate primers (AG) have a minimum film formation temperature (measured on a film-forming bench with temperature gradient, DIN ISO 2115:2001-04) of <30° C., preferably <15° C., more preferably <5° C.

In order to be able to achieve a suitable minimum film formation temperature, the solvents or cosolvents that are customary in coating compositions, for example n-butoxypropanol, dipropylene glycol methyl ether, are added, which evaporate after application, or it is possible to add further polymer dispersions.

In one embodiment, the polyacrylate primer (AG) has a proportion of solvents within the meaning of TRGS 610, January 2011 edition, section 2.5, of less than 1%. (Section 2.5 of said standard procedure defines solvents as follows: solvents are volatile organic substances and mixtures thereof that have a boiling point ≤200° C., are liquid under standard conditions (20° C. and 101.3 kPa) and are used to dissolve or to dilute other substances without chemically altering them.)

In a preferred embodiment, the polyacrylate primer (AG) has a proportion of solvents within the meaning of TRGS 610, January 2011 edition, section 2.5, of less than 1% and contains a polyurethane dispersion having a minimum film formation temperature of less than 5° C.

In a particularly preferred embodiment, the polyacrylate primer (AG) has a proportion of solvents within the meaning of TRGS 610, January 2011 edition, section 2.5, of less than 1% and contains a polyurethane dispersion having a minimum film formation temperature of less than 5° C. and a content of ketones or aldehydes of less than 1 percent by weight.

In a very particularly preferred embodiment, the polyacrylate primer (AG) has a proportion of solvents within the meaning of TRGS 610, January 2011 edition, section 2.5, of less than 1% and contains a polyurethane dispersion having a minimum film formation temperature of less than 5° C.

In a further embodiment, it is possible to add further compounds X3Y3 to the polyacrylate primer (AG) that can react with further reactive groups that may be present in the aqueous polymer dispersion.

For example, these compounds are X3Y3 compounds containing carbodiimide groups (carbodiimide crosslinkers) that can react, for example, with any carboxylic acid groups present in the polymer dispersion. These compounds X3Y3 are preferably added in such amounts that there are 1.5 to 2.5 carbodiimide groups for any and each carboxylic acid group present in the polymer dispersion.

For example, these compounds are X3Y3 compounds containing isocyanate groups (isocyanate crosslinkers) that can react, for example, with any isocyanate-reactive groups (e.g. hydroxyl groups) present in the polymer dispersion. These compounds XY are preferably added in such amounts that there are 1 to 3 isocyanate groups for any and each isocyanate-reactive group present in the polymer dispersion. Suitable compounds XY containing isocyanate groups are hydrophilized aromatic or aliphatic polyisocyanates as described in Ulrich Meier-Westhues, Polyurethane Lacke, Kleb- and Dichtstoffe [Polyurethane Paints, Adhesives and Sealants], Vincenz Hannover, 2007 chapter 3.6. Such compounds are available, for example, from Covestro Deutschland under the Bayhydur® trade name.

The polyacrylate primers (AG) are usable in accordance with the invention for bases present in the construction, such as screeds or wood surfaces, in combination with silane-modified polymer adhesives for the bonding of wood, cork, linoleum, rubber and/or PVC floors. More preferably, the bases are porous bases, especially cement screeds, and the floors are wood floors.

The polyacrylate primers (AG) have very good adhesion to bases present in the construction, which may still contain residual amounts of water.

According to the invention, the composition based on silane-modified polymers (KS) is applied to the polyacrylate primer (AG) after the polyacrylate primers (AG) have been applied to the base present in the construction. The composition based on silane-modified polymers (KS) is preferably not applied until between 1-72 h, preferably 1-48 h, more preferably 2-24 h, after application of the polyacrylate primer (AG). In other words, the aqueous layer produced by application of the polyacrylate primer AG is “stored” for this period of time. In the course of this storage, the dispersion dries to give a polymer film. The drying of the polyacrylate primer (AG) is accelerated by good ventilation and/or at low relative humidity (e.g. dry warm air).

The polyacrylate primers (AG) can be applied, for example, with a microfiber paint roller, a nylon plush roller or other methods suitable for application of coating compositions.

Compositions based on silane-modified polymers (KS) are applied, for example, by the known methods for the bonding of floor coverings. These are described, for example, in the TKB information sheets from the German Adhesives Association: https://www.klebstoffe.com/die-welt-des-klebens/informationen/publikationen/merkblaetter/bauklebstoffe-verlegewerkstoffe.html.

According to the invention, the composition based on silane-modified polymers (KS) can be applied as early as 1 h after application of the polyacrylate primer (AG) without any apparent plasticizer instability in the form of partial detachment of the primer and/or adhesion problems (adhesive failure under tensile or shear stress).

According to the invention, the composition based on silane-modified polymers (KS) can be applied even up to 72 h after application of the polyacrylate primer (AG) without any resultant adhesion problems (adhesive failure under tensile or shear stress) between the primer and the adhesive.

It is particularly surprising that, in the context of the present invention of the layer structure, there is no apparent reaction of isocyanate groups in the polyacrylate primer (AG) that are still present on application of the composition based on silane-modified polymers (KS) with isocyanate-reactive groups that are present in the composition based on silane-modified polymers (KS) or are eliminated in the course of curing.

The present invention provides a layer structure comprising at least one primer layer (G) obtainable from a polyacrylate primer (AG) and at least one composition based on silane-modified polymers (KS) applied thereto.

The present invention preferably provides the above-disclosed layer structure comprising at least one primer layer (G) obtainable from a polyacrylate primer (AG), characterized in that the polyacrylate primer (AG) is in the form of an aqueous polymer dispersion, where this aqueous polymer dispersion contains water-dispersed polymer particles and is producible by free-radical polymerization of monomers comprising
a) at least 50 percent by weight, based on the total amount of monomers a) to d), of at least one monomer selected from the group consisting of C₁- to C₂₀-alkyl acrylates, C₁- to C₂₀-alkyl methacrylates, vinyl esters of carboxylic acids containing up to 20 carbon atoms, vinylaromatics having up to 20 carbon atoms, vinyl halides, vinyl ethers of alcohols containing 1 to 10 carbon atoms, aliphatic hydrocarbons having 2 to 8 carbon atoms and one or two double bonds, and mixtures of these monomers, and
b) at least 0.1 percent by weight, based on the total amount of monomers a) to d), of at least one monomer having at least one acid group and mixtures of these monomers, and
c) at least 0.1 to 5 percent by weight, based on the total amount of monomers a) to d), of at least one ethylenically unsaturated compound having at least one functional group selected from keto groups and aldehyde groups,
   wherein the aqueous polymer dispersion, in addition to the water-dispersed polymer particles, contains at least one compound AH having at least two functional groups that can enter into a crosslinking reaction with the keto groups or with the aldehyde groups,
   where the molar ratio of the groups in compound AH that are reactive with keto groups or with aldehyde groups to the keto and aldehyde groups in monomer b) is 1:10 to 2:1,
d) optionally further monomers and
   at least one curable composition based on silane-modified polymers (KS) that has been applied to the primer layer (G), characterized in that the silane-modified polymers at least one end group of the general formula (I)

-Aₙ-R—SiVYZ (I) in which
A is a divalent binding group containing at least one heteroatom,
R is a divalent hydrocarbyl radical having 1-12 carbon atoms,
V, Y, Z are substituents on the silicon atom that are independently C₁-C₈-alkyl, C₁-C₈-alkoxy or C₁-C₈-acyloxy groups, where at least one of the V, Y, Z radicals is a C₁-C₈-alkoxy or C₁-C₈-acyloxy group, and
n is 0 or 1,
is present.

The present invention more preferably provides the above-disclosed layer structure containing at least one primer layer (G) obtainable from a polyacrylate primer (AG), characterized in that the polyacrylate primer (AG) is in the form of an aqueous polymer dispersion, where this aqueous polymer dispersion contains water-dispersed polymer particles and is producible by free-radical polymerization of monomers comprising

a) 50 to 90 percent by weight, based on the total amount of monomers a) to d), of at least one monomer selected from the group of methyl methacrylate, methyl acrylate, butyl acrylate, n-butyl acrylate, ethyl acrylate, 2-ethylhexyl acrylate, 2-propylheptyl acrylate, n-hexyl acrylate, n-octyl acrylate, hexyl acrylate, octyl acrylate, benzyl (meth)acrylate, isobutyl acrylate, tert-butyl (meth)acrylate, cyclohexyl (meth)acrylate, vinyl laurate, vinyl stearate, vinyl propionate, vinyl versatate, vinyl acetate, vinyltoluene, alpha- and para-methylstyrene, styrene, alpha-butylstyrene, 4-n-butylstyrene, 4-n-decylstyrene, vinyl chloride, vinylidene chloride, vinyl methyl ether and vinyl isobutyl ether and mixtures of these monomers, and

b) 0.5 to 5 percent by weight, based on the total amount of monomers a) to d), of at least one monomer having at least one acid group selected from the group of alpha,beta-monoethylenically unsaturated mono- and dicarboxylic acids, monoesters of alpha,beta-monoethylenically unsaturated dicarboxylic acids, the anhydrides of the aforementioned alpha,beta-monoethylenically unsaturated carboxylic acids and ethylenically unsaturated sulfonic acids, phosphonic acids or dihydrogenphosphates and water-soluble salts thereof and mixtures of these monomers, and

c) 0.2 to 5 percent by weight, based on the total amount of monomers a) to d), of at least one ethylenically unsaturated compound having at least one functional group selected from keto groups and aldehyde groups, selected from the group of acrolein, methacrolein, vinyl alkyl ketones having 1 to 20 carbon atoms, formylstyrene, alkyl (meth)acrylates having one or two keto or aldehyde groups, or one aldehyde and one keto group, in the alkyl radical, where the alkyl radical preferably comprises 3 to 10 carbon atoms in total, N-oxoalkyl(meth)acrylamides of the formula R₆—C(═O)—R₇—NH—C(═O)—CR₈═CH₂ where R₆ and R₈ are independently hydrogen or a hydrocarbyl group having 1 to 10 carbon atoms, and R₇ is a hydrocarbyl group having 2 to 15 carbon atoms,

where the aqueous polymer dispersion, in addition to the water-dispersed polymer particles, contains at least one compound AH having at least two functional groups that can enter into a crosslinking reaction with the keto groups or with the aldehyde groups, selected from the group of oxalic dihydrazide, malonic dihydrazide, succinic dihydrazide, carbodihydrazide, glutaric dihydrazide, adipic dihydrazide, sebacic dihydrazide, maleic dihydrazide, fumaric dihydrazide, itaconic dihydrazide, isophthalic dihydrazide, ethylenediamine, propylenediamine, tetramethylenediamine, pentamethylenediamine, hexamethylenediamine, diethylenetriamine, triethylenetetramine, polyethyleneimines, partly hydrolyzed polyvinylformamides, ethylene oxide and propylene oxide adducts of amines, such as the “Jeffamines”, cyclohexanediamine and xylylenediamine,

where the molar ratio of the groups in compound AH that are reactive with keto groups or with aldehyde groups to the keto and aldehyde groups in monomer b) is 1:10 to 2:1,

d) optionally further monomers d) having a proportion of 5 to 15 percent by weight, based on the total amount of monomers a) to d), selected from the group of acrylamide, methacrylamide, N-methylolacrylamide, N-methylolmethacrylamide, or phenyloxyethylglycol mono(meth)acrylate, hydroxyethyl acrylate, hydroxyethyl methacrylate, hydroxypropyl acrylate, hydroxypropyl methacrylate, 4-hydroxybutyl acrylate, 2-aminoethyl (meth)acrylate, tert-butylaminoethyl methacrylate, acrylonitrile, methacrylonitrile, vinyl, allyl and methallyl glycidyl ethers and glycidyl (meth)acrylate, butanediol di(meth)acrylate, ally! methacrylate and hydroxyalkyl (meth)acrylates having 1 to 10 carbon atoms in the alkyl group, and

at least one curable composition based on silane-modified polymers (KS) that has been applied to the primer layer (G), characterized in that the silane-modified polymers at least one end group of the general formula (I) in which
A is an oxygen atom or an —NR′— group in which R′ is a hydrogen atom or an alkyl or aryl radical having 1 to 12 carbon atoms, amide, carbamate, urea, imino, carboxylate, carbamoyl, amidino, carbonate, sulfonate or sulfinate group,
R is a divalent hydrocarbyl radical having 1-6 carbon atoms,
V, Y, Z are substituents on the silicon atom and are each independently a methyl, ethyl, methoxy or ethoxy group, where at least one of the V, Y and Z radicals is a methoxy or ethoxy group,
n is 0 or 1,
is present.

The present invention even more preferably provides an above-disclosed layer structure containing at least one primer layer (G) obtainable from a polyacrylate primer (AG), characterized in that the polyacrylate primer (AG) is in the form of an aqueous polymer dispersion, where this aqueous polymer dispersion contains water-dispersed polymer particles and is producible by free-radical polymerization of monomers comprising

a) 80 to 90 percent by weight, based on the total amount of monomers a)-d), of at least one monomer selected from the group of methyl methacrylate, ethyl acrylate and styrene and mixtures of these monomers, and

b) 0.5 to 3.5 percent by weight, based on the total amount of monomers a)-d), of at least one monomer having at least one acid group, selected from the group of itaconic acid, acrylic acid and methacrylic acid and mixtures of these monomers, and

c) 1 to 3 percent by weight, based on the total amount of monomers a) to d), of at least one ethylenically unsaturated compound having at least one functional group selected from keto groups and aldehyde groups, selected from the group of acetoacetate (meth)acrylate, acetoacetoxyethyl (meth)acrylate and diacetoneacrylamide,

where the aqueous polymer dispersion, in addition to the water-dispersed polymer particles, contains at least one compound AH having at least two functional groups that can enter into a crosslinking reaction with the keto groups or with the aldehyde groups, selected from the group of oxalic dihydrazide, malonic dihydrazide, succinic dihydrazide, carbodihydrazide, glutaric dihydrazide, adipic dihydrazide, sebacic dihydrazide, maleic dihydrazide, fumaric dihydrazide, itaconic dihydrazide, isophthalic dihydrazide, ethylenediamine, propylenediamine, tetramethylenediamine, pentamethylenediamine, hexamethylenediamine, diethylenetriamine, triethylenetetramine, polyethyleneimines, partly hydrolyzed polyvinylformamides, ethylene oxide and propylene oxide adducts of amines, such as the “Jeffamines”, cyclohexanediamine and xylylenediamine, where the molar ratio of the groups in compound AH that are reactive with keto groups or with aldehyde groups to the keto and aldehyde groups in monomer b) is 1:10 to 2:1,

d) optionally further monomers d) having a proportion of 5 to 15 percent by weight, based on the total amount of monomers a) to d), selected from the group of acrylamide, methacrylamide, N-methylolacrylamide, N-methylolmethacrylamide, or phenyloxyethylglycol mono(meth)acrylate, hydroxyethyl acrylate, hydroxyethyl methacrylate, hydroxypropyl acrylate, hydroxypropyl methacrylate, 4-hydroxybutyl acrylate, 2-aminoethyl (meth)acrylate, tert-butylaminoethyl methacrylate, acrylonitrile, methacrylonitrile, vinyl, allyl and methallyl glycidyl ethers and glycidyl (meth)acrylate, butanediol di(meth)acrylate, allyl methacrylate and hydroxyalkyl (meth)acrylates having 1 to 10 carbon atoms in the alkyl group, and

at least one curable composition based on silane-modified polymers (KS) that has been applied to the primer layer (G), characterized in that the silane-modified polymers at least one end group of the general formula (I) in which
A is an oxygen atom or an —NR′— group in which R′ is a hydrogen atom or an alkyl or aryl radical having 1 to 12 carbon atoms, amide, carbamate, urea, imino, carboxylate, carbamoyl, amidino, carbonate, sulfonate or sulfinate group,
R is a divalent hydrocarbyl radical having 1-6 carbon atoms,
V, Y, Z are substituents on the silicon atom and are each independently a methyl, ethyl, methoxy or ethoxy group, where at least one of the V, Y and Z radicals is a methoxy or ethoxy group,
n is 0 or 1,
is present.

The present invention likewise preferably provides the above-disclosed layer structure comprising at least one primer layer (G) obtainable from a polyacrylate primer (AG), characterized in that the polyacrylate primer (AG) has a proportion of solvents within the scope of TRGS 610, January 2011 edition, section 2.5, of less than 1%.

The present invention likewise preferably provides the above-disclosed layer structure comprising at least one primer layer (G) obtainable from a polyacrylate primer (AG), characterized in that the polyacrylate primer (AG) contains a polyurethane dispersion having a minimum film formation temperature of less than 5° C.

The present invention likewise preferably provides the above-disclosed layer structure comprising at least one primer layer (G) obtainable from a polyacrylate primer (AG), characterized in that the polyacrylate primer (AG) comprises further compounds X3Y3 that can react with reactive groups present in the aqueous polymer dispersion, selected from the group of compounds containing carbodiimide groups (carbodiimide crosslinkers) that can react with carboxylic acid groups present in the polymer dispersion.

The present invention likewise preferably provides the above-disclosed layer structure comprising at least one primer layer obtainable from a polyacrylate primer (AG), characterized in that the primer layer is obtained by storage of an aqueous layer produced using the polyacrylate primer (AG) for 1 to 72 hours.

The present invention further provides a layer system comprising at least one of the above-disclosed layer structures comprising at least one primer layer (G) obtainable from a polyacrylate primer (AG) and curable composition based on silane-modified polymers (KS) applied thereto.

The present invention further provides a layer system comprising at least one of the above-disclosed layer structures comprising at least one primer layer (G) obtainable from a polyacrylate primer (AG) and curable composition based on silane-modified polymers (KS) applied thereto and substrate, for example floor covering, bonded thereto.

The present invention further provides a method of bonding floor coverings to pretreated bases using at least one of the above-disclosed layer structures comprising at least one primer layer (G) obtainable from a polyacrylate primer (AG) as pretreatment and at least one curable composition based on silane-modified polymers (KS) as adhesive.

The present invention preferably further provides the above-disclosed method, characterized in that the polyacrylate primer (AG) is applied in one layer.

The present invention even more preferably further provides the above-disclosed method, characterized in that a polyacrylate primer (AG) is first applied to the base and the floor covering is subsequently bonded to the base thus pretreated with at least one curable composition based on silane-modified polymers (KS), characterized in that the curable composition based on silane-modified polymers (KS) is applied between 1-72 h, preferably 1-48 h, more preferably 2-24 h, after the application of the polyacrylate primer (AG).

The present invention further provides for the use of at least one of the above-disclosed layer structures comprising at least one primer layer (G) obtainable from a polyacrylate primer (AG) and at least one curable composition based on silane-modified polymers (KS) in the bonding of a floor covering on a base.

The present invention preferably further provides for the above-disclosed use of at least one of the above-disclosed layer structures comprising at least one primer layer (G) obtainable from a polyacrylate primer (AG) and at least one curable composition based on silane-modified polymers (KS) in the sealing of joins, for example building material joins, joins between facade elements.

The present invention further provides a kit of parts comprising at least one of the above-disclosed polyacrylate primers (AG) or at least one primer layer (G) obtainable from a polyacrylate primer (AG) and at least one of the above-disclosed curable compositions based on silane-modified polymers (KS).

The present invention preferably further provides the above-disclosed kit of parts for use for construction of a layer system.

The present invention further provides the above-disclosed kit of parts for the bonding of a floor covering on a base.

The present invention further provides the above-disclosed kit of parts for the sealing of joins.

The present invention further provides the above-specified method of bonding floor coverings to pretreated (primed) bases using at least one of the above-specified layer structures comprising at least one primer layer (G) obtainable from a polyacrylate primer (AG) as pretreatment and at least one curable composition based on silane-modified polymers (KS) as adhesive, characterized in that the polyacrylate primer (AG) is applied in one layer.

The present invention further provides the above-specified method of bonding floor coverings to pretreated bases using at least one of the above-specified layer structures comprising at least one primer layer (G) obtainable from a polyacrylate primer (AG) as pretreatment and at least one curable composition based on silane-modified polymers (KS) as adhesive, characterized in that a polyacrylate primer (AG) is first applied to the base and the floor covering is subsequently bonded to the base thus pretreated with at least one curable composition based on silane-modified polymers (KS), characterized in that the curable composition based on silane-modified polymers (KS) is applied between 1-72 h, preferably 1-48 h, more preferably 2-24 h, after the application of the polyacrylate primer.

The substrates to which the polyacrylate primer (AG) is applied preferably have a surface temperature on application between 5 and 35 degrees C.

The present invention further provides a layer system comprising a base, at least one primer layer (G) obtainable from a polyacrylate primer (AG), at least one curable composition based on silane-modified polymers (KS) applied thereto and floor covering bonded thereto, obtainable by the method described above.

The present invention further provides a layer system comprising a base, at least one primer layer (G) obtainable from a polyacrylate primer (AG), at least one curable composition based on silane-modified polymers (KS) applied thereto and floor covering bonded thereto, wherein the polyacrylate primer (AG) and the curable composition based on silane-modified polymers (KS) correspond to the above description.

The present invention further provides for the use of at least one of the above-specified layer structures comprising at least one primer layer (G) obtainable from a polyacrylate primer (AG) and at least one curable composition based on silane-modified polymers (KS) in the bonding of a floor covering on a base.

Useful bases especially include the bases that are customary in interior fitout. These are, for example, concrete, cement, cement screed, self-leveling cement screed, cement mortar, cement-bound wood fibers, ceramic, natural rock, calcium sulfate screed, self-leveling calcium sulfate screed, magnesite screed, wood, woodbase material, plywood, cork, gypsum, gypsum fiber, gypsum board, hard fiber, mineral spackling compound, textile fibers material or a layer structure of these materials.

Examples of useful floor coverings include linoleum coverings, PVC coverings, rubber coverings, vulcanized rubber coverings, textile floor coverings, laminate or wood covering elements. In a preferred embodiment, the floor covering is a wood covering, especially parquet, very particularly solid parquet.

The present invention further provides for the use of at least one of the above-specified layer structures comprising at least one primer layer (G) obtainable from a polyacrylate primer (AG) and at least one curable composition based on silane-modified polymers (KS) in the sealing of joins, for example building material joins, joins between facade elements. The polyacrylate primer (AG) may be applied here to just one substrate or to both substrates that form the join.

The present invention further provides a method of sealing joins between 2 substrates using at least one of the above-disclosed layer structures comprising at least one primer layer (G) obtainable from a polyacrylate primer (AG) as pretreatment and at least one curable composition based on silane-modified polymers (KS) as sealing compound.

The present invention further provides the method described above, characterized in that a polyacrylate primer (AG) is first applied to at least one of the two surfaces of a join formed by 2 substrates and at least one curable composition based on silane-modified polymers (KS) as sealing compound is subsequently introduced into the join, and in that the curable composition based on silane-modified polymers (KS) is introduced between 1-72 h, preferably 1-48 h, more preferably 2-24 h, after the application of the polyacrylate primer to the surface(s) of the join.

What is meant by “introduced into the join” in the case that both surfaces of the join are primed is that the sealing compound is introduced between the two primer layers, and, in the case that just one surface of the join is primed, the sealing compound is introduced between the primer layer of the primed join surface and the unprimed join surface.

The present invention further provides a layer system comprising 2 substrates, at least one primer layer (G1) obtainable from a polyacrylate primer (AG) on the side of the first substrate that faces the second substrate and optionally at least one primer layer (G2) obtainable from a polyacrylate primer (AG) on the side of the second substrate that faces the first substrate, and at least one curable composition based on silane-modified polymers (KS) disposed between the primer layer G1 and the second substrate or primer layer G2, obtainable by the method described above.

The present invention further provides a layer system comprising 2 substrates, at least one primer layer (G1) obtainable from a polyacrylate primer (AG) on the side of the first substrate that faces the second substrate and optionally at least one primer layer (G2) obtainable from a polyacrylate primer (AG) on the side of the second substrate that faces the first substrate, and at least one curable composition based on silane-modified polymers (KS) disposed between the primer layer G1 and the second substrate or primer layer G2, wherein the polyacrylate primer (AG) and the curable composition based on silane-modified polymers (KS) correspond to the above description.

The present invention further provides a kit of parts comprising at least one of the above-specified polyacrylate primers (AG) or at least one primer layer (G) obtainable from a polyacrylate primer (AG) and at least one of the above-specified curable compositions based on silane-modified polymers (KS).

The present invention further provides the above-specified kit of parts comprising at least one of the above-specified polyacrylate primers (AG) or at least one primer layer (G) obtainable from a polyacrylate primer (AG) and at least one of the above-specified curable compositions based on silane-modified polymers (KS) for use for construction of a layer system.

The present invention further provides the above-specified kit of parts comprising at least one of the above-specified polyacrylate primers (AG) or at least one primer layer (G) obtainable from a polyacrylate primer (AG) and at least one of the above-specified curable compositions based on silane-modified polymers (KS) for use for construction of a layer system for the bonding of a floor covering on a base.

The present invention further provides the above-specified kit of parts comprising at least one of the above-specified polyacrylate primers (AG) or at least one primer layer (G) obtainable from a polyacrylate primer (AG) and at least one of the above-specified curable compositions based on silane-modified polymers (KS) for use for construction of a layer system for the sealing of joins.

Experimental

Test Methods

Chemicals:

Acrylic acid (ACS), CAS 79-10-7, Aldrich, DE

Methyl methacrylate (MMA), CAS 80-62-6, Aldrich, DE

Styrene (S), CAS 100-42-5, Aldrich, DE

n-Butyl acrylate (BA), CAS 141-32-2, Aldrich, DE

Hydroxyethyl methacrylate (HEMA), CAS 868-77-9, Aldrich, DE

Ethylhexyl methacrylate (EHMA), CAS 868-77-9, Aldrich, DE

Adipic dihydrazide (ADH); CAS 1071-93-8; Merck, DE

Diacetoneacrylamide (DAAM); CAS 2873-97-4, Aldrich; DE

Acrylamide (AAM); CAS 79-06-1, Aldrich; DE

Ammonium persulfate (APS), CAS 7727-54-0, Aldrich, DE

Tannemul 951 emulsifier (STD), CAS 68610-22-0, Tanatex, DE

Dipropylene glycol monomethyl ether (DPM), Dowanol DPM, CAS 34590-94-8, DOW, DE

Propylene glycol n-butyl ether (PNB), Dowanol PnB, CAS 29387-86-8, DOW, DE

Preparation of a Silane-Terminated Prepolymer Having Urethane and Urea Groups P1

In a 21 sulfonation flask with lid, stirrer, thermometer and nitrogen flow, 880.1 g of a difunctional propylene glycol of OH number 13.4 mg KOH/g (ascertained to DIN 53240-1 (2012)) (Acclaim® 8200 N polyol from Covestro Deutschland AG; Leverkusen DE) was reacted with 46.7 g of isophorone diisocyanate (IPDI, Desmodur® I, Covestro Deutschland AG, NCO content 37.8%, molar mass 222 g/mol, CAS No. 4098-71-9) at 60° C. with addition of 0.04 g of dibutyltin dilaurate for 5 h. After addition of 74 g of diethyl N-(3-trimethoxysilylpropyl)aspartate (prepared according to EP-A 596 360, example 5), the mixture was stirred until it was no longer possible to observe any isocyanate band in the IR spectrum.

Production of a Curable Composition KS1 (e.g. Floor Covering Adhesive)

A curable composition based on polymer composition P1 was produced by the following method: 551 g of Omyalite 95 T filler (calcium carbonate, from Omya) that had been dried beforehand in an air circulation drying cabinet at 100° C. for 16 h is dispersed with 218 g of plasticizer (phenyl alkanesulfonate, Mesamoll, from Lanxess, CAS Reg. No. 091082-17-6 (ASE), water content 0.03% by weight), 178 g of polymer composition P1, 8.1 g of Cab-O-Sil TS 720 (hydrophobic fumed silica filler, from Cabot, water content about 0.11% by weight), 23 g of Dynasilan VTMO (silane-based desiccant, from Evonik, vinyltrimethoxysilane, CAS No. 2768-02-7) and 1.2 g of 1,8-diazabicyclo[5.4.0]undec-7-ene (Sigma-Aldrich Co. LLC) in a laboratory dissolver with butterfly stirrer (200 revolutions/min) and dissolver disk (2500 revolutions/min) for 15 min with static vacuum and cooling. What is meant here by static vacuum is that the apparatus is evacuated down to a pressure of 200 mbar (dynamic vacuum) and then the connection to the vacuum pump is severed. The cooling was chosen such that a temperature of 65° C. is not exceeded throughout the production. Thereafter, 15.4 g of Dynasilan 1146 (aminosilane adhesion promoter, from Evonik) was added and mixed with a dissolver disk (1000 revolutions/min) under static vacuum and cooling for 10 min. Lastly, the mixture was mixed further with a dissolver disk (1000 revolutions/min) under dynamic vacuum for 5 min.

Preparation of the Dispersions:

The paragraph which follows describes a general synthesis method for production of the dispersions of the invention; the specific compositions of the individual experiments can be found in tab. 1.

General Synthesis Method:

A 3 1 glass reactor with controlled heating and cooling and stirrer motor under a nitrogen atmosphere is charged with the portions by weight of water and emulsifier specified under WO in table 1. The solution is then heated up to 80° C. On attainment of the polymerization temperature, the monomer mixture M1 and the initiator solution W1 are added within 30 min via a metering pump for the production of the internal seed, then stirring is continued for another 30 min. Thereafter, the monomer mixture M2 and the aqueous solution W2 are metered in at 80° C. within 120 min. Subsequently, the monomer mixture M3 and the aqueous solution W3 are added within a period of 120 min. Directly after the metered additions M3 and W3 have ended, the aqueous solution W4 is metered in within 60 min. Stirring of the dispersion is then continued for a period of 60 min, followed by cooling. The pH is adjusted to pH 7 by gradual dropwise addition of the appropriate amount of ammoniacal solution, and the finished dispersion is filtered through a 125 μm filter. This is followed by the addition of the aqueous solution/water W5.

| | | V1 | V2 | V3 | V4 |
|---|---|---|---|---|---|
| W0 | STD | 11.10 | 11.10 | 11.10 | 11.10 |
| | Water | 520.00 | 520.00 | 520.00 | 520.00 |
| M1 | Methyl methacrylate | 14.10 | 14.10 | 14.10 | 28.10 |
| | Ethylhexyl acrylate | 2.50 | 2.50 | 2.50 | 2.50 |
| | Styrene | 14.00 | 14.00 | 14.00 | 0.00 |
| | Acrylic acid | 2.00 | 2.00 | 2.00 | 2.00 |
| | Hydroxyethyl | 3.00 | 3.00 | 3.00 | 3.00 |
| | methacrylate | | | | |
| | Diacetoneacrylamide | | | | |
| | Acrylamide | | | | |
| W1 | APS | 0.50 | 0.50 | 0.50 | 0.50 |
| | Water | 70.00 | 70.00 | 70.00 | 70.00 |
| M2 | Methyl methacrylate | 85.90 | 85.90 | 85.90 | 218.50 |
| | Ethylhexyl acrylate | 8.80 | 8.80 | 8.80 | 8.80 |
| | Styrene | 132.60 | 132.60 | 132.60 | 0.00 |
| | Acrylic acid | 12.10 | 12.10 | 12.10 | 12.10 |
| | Hydroxyethyl | 32.00 | 32.00 | 32.00 | 32.00 |
| | methacrylate | | | | |
| | Diacetoneacrylamide | 6.20 | 6.20 | | |
| | Acrylamide | | | 6.20 | |
| W2 | APS | 2.30 | 2.30 | 2.30 | 2.30 |
| | Water | 555.00 | 555.00 | 555.00 | 555.00 |
| | STD | 11.10 | 11.10 | 11.10 | 11.10 |
| M3 | Methyl methacrylate | 171.60 | 171.60 | 171.60 | 353.40 |
| | Ethylhexyl acrylate | 177.30 | 177.30 | 177.30 | 177.30 |
| | Styrene | 169.40 | 169.40 | 169.40 | 0.00 |
| | Acrylic acid | 14.10 | 14.10 | 14.10 | 14.10 |
| | Hydroxyethyl | 72.00 | 72.00 | 72.00 | 72.00 |
| | methacrylate | | | | |
| | Diacetoneacrylamide | 12.40 | 12.40 | | |
| | Acrylamide | | | 12.40 | |
| W3 | APS | 2.30 | 2.30 | 2.30 | 2.30 |
| | Water | 70.00 | 70.00 | 70.00 | 70.00 |
| W4 | APS | 2.30 | 2.30 | 2.30 | 2.30 |
| | Water | 70.00 | 70.00 | 70.00 | 70.00 |
| W5 | Adipic dihydrazide | 9.57 | | | |
| | Water | 147.00 | 156.57 | 156.57 | 156.57 |

Production of Solventborne Primers AG1-AG4

5 g each of PNB and DPM were added to 90 g of the dispersions (V1-V4) in a 150 ml glass bottle, and the components in the bottle were mixed by vigorous shaking.

Production of the Solvent-Free Primer AG5

40 g of a polyurethane dispersion produced analogously to EP2440592, example 3, (except with solids content 35%) was added to 60 g of dispersion V1 in a 150 ml glass bottle, and the components in the bottle were mixed by vigorous shaking.

The primers AG1-AG5 thus obtained were examined further.

Determination of Lap Shear Strength

Lap shear strength was determined using test specimens with a simple overlap, made from two pieces of beechwood with a length of overlap of 10 mm and a bonding gap thickness of about 1 mm. The pieces of beechwood used for the purpose each have the following dimensions: length=40 mm, width=20 mm, thickness=5 mm, and were stored under daytime conditions of 23° C./50% rel. humidity for at least 1 week before use.

Unless stated otherwise, the test specimens were produced by using one of the two overlapping pieces of beechwood without further pretreatment in each case, with pretreatment or priming of the second piece of beechwood as described below under “Production of the pretreated pieces of beechwood for the production of the test specimens for the lap shear strength test”. The adhesive was applied to the pretreated piece of beechwood after the wait time specified in each case, and the second piece of beechwood was applied (untreated). Any adhesive squeezed out to the side was removed immediately with a spatula. The test specimens were stored in a suitable device for establishment of the adhesive gap thickness with the aid of metal plates. Two untreated pieces of beechwood were used in each of the experiments without priming/pretreatment.

The test specimens were stored at 23° C./50% rel. humidity for 3 days. (STORAGE SEQUENCE 1)

Lap shear strength was measured in each case using a tensile tester at a feed rate of 100 mm/min. This involved stretching the test specimens until fracture and measuring the forces required. The results given correspond to the arithmetic mean of 5 tests.

Production of the Pretreated Pieces of Beechwood for the Production of the Test Specimens for the Lap Shear Strength Test

The mixture used as primer is applied to the beechwood test specimens in one layer by means of a brush (coat weight 170 g/m²). Prior to the application of the curable compositions, the pretreated or primed pieces of beechwood thus obtained were stored at 23 degrees Celsius and 50% relative humidity for 4 h, unless stated otherwise, before the curable compositions were applied.

With this structure (beechwood/curable composition/primer/beechwood), it was possible to examine the strength of the composite composed of primer and cured adhesive under lap shear stress. Particularly by comparison with a structure without the primer (beechwood/curable composition/beechwood), it was found here whether the priming has a distinct adverse effect on bond strength, which is undesirable in practice.

### EXAMPLES 1-5

The lap shear strengths were ascertained using the primers AG1-AG5 and the curable composition KS1. All primers based on dispersions from experiments V2-V4 that contain either no compound AH or no monomer c), in the case of a wait time of only 4 h prior to adhesive application, lead to inadequate bonding results and to poor bond strengths as a result. Only in the case of combination of monomer c) and compound AH) was cohesive failure of the adhesive and sufficient bond strength achieved. Moreover, no softening of the primer AG1 resulting from plasticizer migration from the adhesive into the marginal regions was observed.

| | BSP 1 | BSP 2 | BSP 3 | BSP 4 | BSP 5 |
|---|---|---|---|---|---|
| Primer | AG1 | AG2 | AG3 | AG4 | AG5 |
| Failure in the lap shear test | K | A | A | A | K |
| Lap shear strength [N/mm2] | 2.4 | 1.2 | 0.9 | 1.4 | 2.4 |

A: adhesive failure (no adhesion between primer and adhesive)
K: cohesive failure (adhesion between primer and adhesive)

### EXAMPLES 2-5: COMPARATIVE EXAMPLES

### EXAMPLE 1a

### (Inventive)

5 g of an aqueous dispersion of a hydrophilically modified, polyfunctional carbodiimide (water content 60%, —N═C═N— content 1%, Desmodur® XP 2802, Covestro Deutschland AG) was added to 100 g of primer AG1. The mixture obtained was used as primer analogously to examples 1-5, with a wait time of 4 h in one case and of 24 h in another. In both cases, a lap shear strength of 2.5 N/mm2 with cohesive failure of the adhesive was ascertained in the lap shear test.

EXAMPLE 6

### (Comparative)

By way of comparison, the experiments were repeated without application of primer to the wood. Both beechwood test specimens were thus not pretreated. Predominantly cohesive failure was observed with a lap shear strength of 3.0 N/mm2.

### EXAMPLE 7

### (Comparative)

Analogously to example 6, test specimens without primer that had been produced and stored in a comparable manner, in the case of bonding with a noninventive composition based on a curing polyvinylacetate dispersion with aluminum chloride metal salt crosslinker, achieved a lap shear strength of 11.75 N/mm² (adherend failure). In the case of an analogous experiment with the inventive primer AG1 and with wait time 4 h, by contrast, only a lap shear strength of 7 N/mm² was attained, with observation of adhesive failure.

In combination with this noninventive adhesive, the priming of the invention severely reduced the lap shear strength of the system. This was not observed in the case of the layer structure composed of primer of the invention and curing composition of the invention.

Example 7 shows that the selection of the curable composition (KS) in layer structure with the inventive primer AG is not trivial since, when the primer AG is used with a noninventive adhesive, the result is a distinct reduction in overall strength in the system compared to the unprimed system, and it is then not possible to fully exploit the performance capacity of the adhesive.

### EXAMPLE 8

### (Comparative)

Analogously to example 6, test specimens without primer that had been produced and stored in a comparable manner, in the case of bonding with a noninventive composition based on a curing 2K epoxy resin adhesive (Araldite 2011|50 ml twin cartridge with ZMS), achieved a lap shear strength of 13 N/mm² (adherend failure). In the case of an analogous experiment with the inventive primer AG1 and with wait time 4 h, by contrast, only a lap shear strength of 7 N/mm² was attained, with observation of adhesive failure.

The priming of the invention here severely reduced the lap shear strength of the system. This was not observed in the case of the layer structure composed of primer of the invention and curing composition of the invention.

Example 8 shows that the selection of the curable composition (KS) in layer structure with the inventive primer AG is not trivial since, when the primer AG is used with a noninventive adhesive, the result is a distinct reduction in overall strength in the system compared to the unprimed system, and it is then not possible to fully exploit the performance capacity of the adhesive.

### EXAMPLE 9

### Test of Tensile Bonding Capacity of Primer AG1, AG5 and SIKA PRIMER MR FAST

Production and Storage of the Test Specimens:

The tensile bonding capacity of primer AG1 on a previously soaked concrete slab was compared with that of priming based on SIKA PRIMER MR FAST (aqueous, two-component epoxy resin primer, from Sika).

The test specimen used was the top face of Stelcon Ferubin 30×30×3 cm hard concrete slabs, BTE Stelcon Deutschland GmbH, Philippsburger Str. 4 , 76726 Germersheim.

These were stored under standard conditions at 23 degrees Celsius and 50% relative humidity for 28 d, then the top face was brushed with 5% citric acid solution in water and, after a contact time of 20 min, freed of any adhering cement slurries with a brush under running water. Subsequently, the slab was stored in water for 7 d, taken out of the water and set upright, such that water adhering to the surface was able to run off.

AG1 was then applied to the surface of the slabs thus prepared directly after production in a Speedmixer by means of a roller (Moltopren roller) at coat weight about 200 g/m². Thereafter, the primed slabs were stored with their reverse side on plastic sheets at 23 degrees Celsius and 50% relative humidity for 16 h.

To create a uniform layer thickness, the primed slabs were coated with a self-leveling 2-component polyurethane coating (NCO/OH index=1.05/1) based on Setathane D 1150 (castor oil-based branched polyol, from Nuplex, hydroxyl content to DIN 53 240/2 about 4.7% by weight)/Desmodur VL (aromatic polyisocyanate based on diphenylmethane diisocyanate, isocyanate group content to ISO 11909:2007 31.5%), with layer thickness about 1.5 mm. Thereafter, the slabs were again placed with their reverse side on plastic sheets for 24 h.

On one series of slabs (series A), the tensile bonding capacity test was conducted immediately thereafter. A further series (series B) is placed in a water basin by the reverse side such that the water surface runs about 1 cm below the primer and stored in this way at 23 degrees Celsius and 50% relative humidity for 28 d.

Slabs were primed and stored in an analogous manner, except that the AG1 primer was now replaced by SIKA® PRIMER MR FAST (aqueous, 2-component epoxy resin primer, from Sika), produced according to the manufacturer's instructions (mixing ratio of components A:B 2.8/1.4 parts by weight).

Ascertaining Facial Pull-Off Strength:

Facial pull-off strength was ascertained with the HP 850 adhesion test system.

3 drill cores having a diameter of about 5 cm and depth about 5 mm were machined into the top face of the slabs produced and stored as above. The distance between the edges of the drill cores was greater than 4 cm. The bonding face was ground with abrasive paper, freed of dust and degreased with acetone. The test specimens that had been cleaned beforehand (round, diameter 50 mm) were bonded on with the 2K epoxy resin adhesive Metallon FL (Sichelwerke GmbH) in a uniform thin layer with lateral rotation, ensuring that any adhesive that swelled out did not get into the machined groove and was removed if necessary.

After storage at 23 degrees Celsius and 50% relative humidity for 24 h, facial pull-off strength was ascertained and calculated as follows:

Dimension of tear-off force=N/mm²

Area of the 50 mm die=1964 mm²

Value read off=kN

1 kN=1000 N

Tensile bond strength=tear-off force [N]:area [mm²]

TABLE 8
Tensile bond strengths of the primer before and after storage

| | SIKA ® PRIMER | |
|---|---|---|
| | MR FAST | Primer AG1 |
| Series A | 3.6 (fracture in | 2.8 (fracture in concrete) |
| | concrete) | |
| Series B | 3.1 (fracture | 2.6 (fracture between |
| | between concrete | concrete and primer) |
| | and primer) | |

As shown by table 8, the adhesive bond strength of primer AG1 is absolutely comparable to the prior art system, and is in each case well above the value of 1 N/mm² required for elastic parquet adhesives according to DIN EN 14293.

1. A layer structure comprising
at least one primer layer (G) obtained from a polyacrylate primer (AG), wherein the polyacrylate primer (AG) is in the form of an aqueous polymer dispersion, wherein the aqueous polymer dispersion contains water-dispersed polymer particles and is produced by free-radical polymerization of monomers comprising
a) at least 50 percent by weight, based on a total amount of monomers a) to d), of at least one monomer comprising C₁- to C₂₀-alkyl acrylates, C₁- to C₂₀-alkyl methacrylates, vinyl esters of carboxylic acids containing up to 20 carbon atoms, vinylaromatics having up to 20 carbon atoms, vinyl halides, vinyl ethers of alcohols containing 1 to 10 carbon atoms, aliphatic hydrocarbons having 2 to 8 carbon atoms and one or two double bonds, or mixtures of these monomers, and
b) at least 0.1 percent by weight, based on the total amount of monomers a) to d), of at least one monomer having at least one acid group or mixtures of these monomers, and
c) at least 0.1 to 5 percent by weight, based on the total amount of monomers a) to d), of at least one ethylenically unsaturated compound having at least one functional group comprising a keto group or an aldehyde groups
wherein the aqueous polymer dispersion, in addition to the water-dispersed polymer particles, contains at least one compound AH having at least two functional groups that can enter into a crosslinking reaction with the keto groups or with the aldehyde groups,
wherein the molar ratio of the functional groups in compound AH that are reactive with keto groups or with aldehyde groups to the keto and aldehyde groups in monomer b) is 1:10 to 2:1;
d) optionally further monomers and
at least one curable composition based on silane-modified polymers (KS) applied to the primer layer (G), wherein the silane-modified polymers have at least one end group of the general formula (I)
-Aₙ-R—SiVYZ (I)
in which
A is a divalent binding group containing at least one heteroatom,
R is a divalent hydrocarbyl radical having 1-12 carbon atoms,
V, Y, Z are substituents on the silicon atom that are independently C₁-C₈-alkoxy or C₁-C₈-acyloxy groups, where
at least one of the V, Y, or Z radicals is a C₁-C₈-alkoxy or C₁-C₈-acyloxy group, and
n is 0 or 1.

2. The layer structure as claimed in claim 1, comprising
at least one primer layer (G) obtained from a polyacrylate primer (AG), wherein the polyacrylate primer (AG) is in the form of an aqueous polymer dispersion, wherein the aqueous polymer dispersion contains water-dispersed polymer particles and is produced by free-radical polymerization of monomers comprising
a) 50 to 90 percent by weight, based on the total amount of monomers a) to d), of at least one monomer comprising methyl methacrylate, methyl acrylate, butyl acrylate, n-butyl acrylate, ethyl acrylate, 2-ethylhexyl acrylate, 2-propylheptyl acrylate, n-hexyl acrylate, n-octyl acrylate, hexyl acrylate, octyl acrylate, benzyl (meth)acrylate, isobutyl acrylate, tert-butyl (meth)acrylate, cyclohexyl (meth)acrylate, vinyl laurate, vinyl stearate, vinyl propionate, vinyl versatate, vinyl acetate, vinyltoluene, alpha- and para-methylstyrene, styrene, alpha-butylstyrene, 4-n-butylstyrene, 4-n-decylstyrene, vinyl chloride, vinylidene chloride, vinyl methyl ether, vinyl isobutyl ether or mixtures of these monomers, and
b) 0.5 to 5 percent by weight, based on the total amount of monomers a) to d), of at least one monomer having at least one acid group comprising alpha,beta-monoethylenically unsaturated mono- and dicarboxylic acids, monoesters of alpha,beta-monoethylenically unsaturated dicarboxylic acids, the anhydrides of the aforementioned alpha,beta-monoethylenically unsaturated carboxylic acids or ethylenically unsaturated sulfonic acids, phosphonic acids or dihydrogenphosphates, water-soluble salts thereof, or mixtures of these monomers, and
c) 0.2 to 5 percent by weight, based on the total amount of monomers a) to d), of at least one ethylenically unsaturated compound having at least one functional group comprising a keto group or an aldehyde group, comprising acrolein, methacrolein, vinyl alkyl ketones having 1 to 20 carbon atoms, formylstyrene, alkyl (meth)acrylates having one or two keto or aldehyde groups, or one aldehyde and one keto group, in the alkyl radical, where the alkyl radical preferably comprises 3 to 10 carbon atoms in total, or N-oxoalkyl(meth)acrylam ides of the formula R₆—C(═O)—R₇—NH—C(═O)—CR₈═CH₂ where R₆ and R₈ are independently hydrogen or a hydrocarbyl group having 1 to 10 carbon atoms, and R7 is a hydrocarbyl group having 2 to 15 carbon atoms,
wherein the aqueous polymer dispersion, in addition to the water-dispersed polymer particles, contains at least one compound AH having at least two functional groups that can enter into a crosslinking reaction with the keto groups or with the aldehyde groups, comprising oxalic dihydrazide, malonic dihydrazide, succinic dihydrazide, carbodihydrazide, glutaric dihydrazide, adipic dihydrazide, sebacic dihydrazide, maleic dihydrazide, fumaric dihydrazide, itaconic dihydrazide, isophthalic dihydrazide, ethylenediamine, propylenediamine, tetramethylenediamine, pentamethylenediamine, hexamethylenediamine, diethylenetriamine, triethylenetetramine, polyethyleneimines, partly hydrolyzed polyvinylformamides, ethylene oxide and propylene oxide adducts of amines, cyclohexanediamine, or xylylenediamine,
where the molar ratio of the functional groups in compound AH that are reactive with keto groups or with aldehyde groups to the keto and aldehyde groups in monomer b) is 1:10 to 2:1,
d) optionally further monomers d) having a proportion of 5 to 15 percent by weight, based on the total amount of monomers a) to d), comprising acrylamide, methacrylamide, N-methylolacrylamide, N-methylolmethacrylamide, phenyloxyethylglycol mono(meth)acrylate, hydroxyethyl acrylate, hydroxyethyl methacrylate, hydroxypropyl acrylate, hydroxypropyl methacrylate, 4-hydroxybutyl acrylate, 2-am inoethyl (meth)acrylate, tert-butylaminoethyl methacrylate, acrylonitrile, methacrylonitrile, vinyl, allyl or methallyl glycidyl ethers or glycidyl (meth)acrylate, butanediol di(meth)acrylate, allyl methacrylate or hydroxyalkyl (meth)acrylates having 1 to 10 carbon atoms in the alkyl group, and
at least one curable composition based on silane-modified polymers (KS) applied to the primer layer (G), wherein the silane-modified polymers have at least one end group of the general formula (I) in which
A is an oxygen atom or an —NR′— group in which R′ is a hydrogen atom or
an alkyl or aryl radical having 1 to 12 carbon atoms, amide, carbamate, urea, imino, carboxylate, carbamoyl, amidino, carbonate, sulfonate or sulfinate group,
R is a divalent hydrocarbyl radical having 1-6 carbon atoms,
V, Y, Z are substituents on the silicon atom and are each independently a methyl, ethyl, methoxy or ethoxy group, where at least one of the V, Y or Z radicals is a methoxy or ethoxy group,
n is 0 or 1.

3. The layer structure as claimed in claim 1, comprising at least one primer layer (G) obtained from a polyacrylate primer (AG), wherein the polyacrylate primer (AG) has a proportion of solvents within the scope of TRGS 610, January 2011 edition, section 2.5, of less than 1%.

4. The layer structure as claimed in claim 1, comprising at least one primer layer (G) obtained from a polyacrylate primer (AG), wherein the polyacrylate primer (AG) comprises a polyurethane dispersion having a minimum film formation temperature (measured on a film-forming bench with a temperature gradient, DIN ISO 2115:2001-04) of less than 5° C.

5. The layer structure as claimed in claim 1, comprising at least one primer layer (G) obtained from a polyacrylate primer (AG), wherein the polyacrylate primer (AG) comprises further compounds X3Y3 that can react with reactive groups present in the aqueous polymer dispersion, comprising compounds containing carbodiimide groups (carbodiimide crosslinkers) that can react with carboxylic acid groups present in the polymer dispersion.

6. The layer structure as claimed in claim 1, wherein the primer layer (G) is obtained by storage of the aqueous layer produced using the polyacrylate primer (AG) for 1 to 72 hours.

7. A layer system comprising the layer structure of claim 1, comprising at least one primer layer (G) obtained from a polyacrylate primer (AG) and at least one curable composition based on silane-modified polymers (KS) applied thereto.

8. A layer system comprising the layer structure of claim 1, comprising at least one primer layer (G) obtained from a polyacrylate primer (AG) and at least one curable composition based on silane-modified polymers (KS) applied thereto, and substrate bonded thereto, for example floor covering.

9. A method of bonding floor coverings to pretreated bases using the layer structure of claim 1, comprising at least one primer layer (G) obtained from a polyacrylate primer (AG) as pretreatment and at least one curable composition based on silane-modified polymers (KS) as adhesive.

10. The method as claimed in claim 9, wherein the polyacrylate primer (AG) is applied in one layer.

11. The method as claimed in claim 9, wherein a polyacrylate primer (AG) is first applied to a base and a floor covering is subsequently bonded to the base thus pretreated with at least one curable composition based on silane-modified polymers (KS), wherein the curable composition based on silane-modified polymers (KS) is applied between 1-72 h after the application of the polyacrylate primer.

12. A layer system comprising a base, at least one primer layer (G) obtained from a polyacrylate primer (AG), at least one curable composition based on silane-modified polymers (KS) applied thereto and floor covering bonded thereto, wherein the polyacrylate primer (AG) corresponds to one of the polyacrylate primers (AG) of claim 1, and the curable composition based on silane-modified polymers (KS) corresponds to the compositions based on silane-modified polymers (KS) of claim 1.

13. A method of sealing joins between 2 substrates using the layer structures specified in claim 1, comprising at least one primer layer (G) obtained from a polyacrylate primer (AG) as pretreatment and at least one curable composition based on silane-modified polymers (KS) as sealing compound.

14. The method as claimed in claim 13, wherein a polyacrylate primer (AG) is first applied to at least one of the two surfaces of a join formed by 2 substrates and at least one curable composition based on silane-modified polymers (KS) as sealing compound is subsequently introduced into the join, wherein the curable composition based on silane-modified polymers (KS) is introduced between 1-72 h after the application of the polyacrylate primer to the surface(s) of the join.

15. A layer system comprising 2 substrates, at least one primer layer (G1) obtained from a polyacrylate primer (AG) on a side of a first substrate that faces the a second substrate and optionally at least one primer layer (G2) obtained from a polyacrylate primer (AG) on a side of the second substrate that faces the first substrate, and at least one curable composition based on silane-modified polymers (KS) disposed between the primer layer G1 and the second substrate or primer layer G2, wherein the polyacrylate primer (AG) corresponds to one of the polyacrylate primers (AG) described in claim 1 and the curable composition based on silane-modified polymers (KS) corresponds to one of the compositions based on silane-modified polymers (KS) described in claim 1.

16. A kit of parts comprising the polyacrylate primers (AG) or primer layers (G) and the curable compositions based on silane-modified polymers (KS) specified in claim 1.
